(19) United States
(12) Patent Application Publication
(10) Pub. No.: US 2025/0083936 A1
(43) Pub. Date: Mar. 13, 2025

(54) MOTION DETERMINATION METHOD, MOTION DETERMINATION SYSTEM, AND MOTION DETERMINATION APPARATUS

(71) Applicant: NEC Corporation, Minato-ku, Tokyo (JP)

(72) Inventor: Ryutaro YAMAGUCHI, Tokyo (JP)

(73) Assignee: NEC Corporation, Minato-ku, Tokyo (JP)

(21) Appl. No.: 18/723,918

(22) PCT Filed: Mar. 4, 2022
(86) PCT No.: PCT/JP2022/009324

§ 371 Date: Jun. 25, 2024

(51) Int. Cl. B66F 9/24

(52) U.S. Cl. CPC B66F 9/24

(57) ABSTRACT

A motion determination system or a motion determination apparatus acquires object information including information regarding a size of an object. The motion determination system or the motion determination apparatus acquires apparatus information that is information regarding a mobile apparatus that moves an object. The motion determination system or the motion determination apparatus acquires range information indicating a range in which an object can be moved at a motion place which is a place where a motion of transferring the object by the mobile apparatus is executed. The motion determination system or the motion determination apparatus determines the motion of transferring the object is able to be executed on the object at the motion place according to the object information, the apparatus information, and the range information.

### TECHNICAL FIELD

The present disclosure relates to a motion determination method, a motion determination system, and a motion determination apparatus.

### BACKGROUND ART

In a case where an apparatus is operated to install cargo at an installation place such as a shelf or a loading platform of a truck, the driver visually confirms the situation after actually moving to the installation place, and then drives the apparatus or operates work parts in accordance with the visual results.

Unmanned apparatuses that automatically perform such work have also been proposed. For example, Patent Literature 1 discloses an unmanned forklift in which an object confirmation sensor in front is attached to a tip of a chassis, a tip of a carriage, a tip of a fork, and an upper end of a backrest. In the technique described in Patent Literature 1, a height of a load is confirmed by the object confirmation sensor, and whether to execute work is determined.

### CITATION LIST

### Patent Literature

Patent Literature 1: Japanese Unexamined Patent Application Publication No. H10-279297

### SUMMARY OF INVENTION

### Technical Problem

However, in the technique described in Patent Literature 1, although the height of the load can be confirmed, it is necessary to make a determination in consideration of information of the forklift when the cargo is actually placed on an installation place such as a shelf or a loading platform of a truck, and thus it cannot be said that safety can be ensured.

In addition, the same problem may occur not only in a case where the cargo is placed on the placement place by the apparatus but also in a case where the cargo is picked up from the original placement place by the apparatus.

In view of the above circumstances, an object of the present disclosure is to provide a motion determination method, a motion determination system, and a motion determination apparatus capable of performing determination for safely transferring an object by a mobile apparatus.

### Solution to Problem

In order to achieve the above object, the present disclosure provides, as a first aspect, a motion determination method. The motion determination method includes acquiring object information including information regarding a size of an object, acquiring apparatus information that is information regarding a mobile apparatus that moves the object, acquiring range information indicating a range in which an object can be moved at a motion place where a motion of transferring the object by a mobile apparatus is executed, and determining whether the motion of transferring the object is able to be executed on the object at the motion place according to the object information, the apparatus information, and the range information.

A second aspect of the present disclosure provides a motion determination system. The motion determination system includes object information acquisition means for acquiring object information including information regarding a size of an object, apparatus information acquisition means for acquiring apparatus information that is information regarding a mobile apparatus that moves the object, range information acquisition means for acquiring range information indicating a range in which an object can be moved at a motion place where a motion of transferring the object by a mobile apparatus is executed, and determination means for determining whether the motion of transferring the object is able to be executed on the object at the motion place according to the object information, the apparatus information, and the range information.

A third aspect of the present disclosure provides a motion determination apparatus. The motion determination apparatus includes object information acquisition means for acquiring object information including information regarding a size of an object, apparatus information acquisition means for acquiring apparatus information that is information regarding a mobile apparatus that moves the object, range information acquisition means for acquiring range information indicating a range in which an object can be moved at a motion place where a motion of transferring the object by a mobile apparatus is executed, and determination means for determining whether the motion of transferring the object is able to be executed on the object at the motion place according to the object information, the apparatus information, and the range information.

### Advantageous Effects of Invention

According to the present disclosure, it is possible to provide a motion determination method, a motion determination system, and a motion determination apparatus capable of performing determination for safely transferring an object by a mobile apparatus.

### BRIEF DESCRIPTION OF DRAWINGS

FIG. 1 is a block diagram illustrating a configuration example of a motion determination system according to a first example embodiment.

FIG. 2 is a block diagram illustrating a motion determination apparatus as a configuration example of the motion determination system of FIG. 1.

FIG. 3 is a flowchart for illustrating an example of a motion determination method in the motion determination system of FIG. 1 or the motion determination apparatus of FIG. 2.

FIG. 4 is a block diagram illustrating a detailed configuration example of the motion determination system of FIG. 1.

FIG. 5 is a side view schematically illustrating an example of a forklift that is a control target of a motion determination in the motion determination system of FIG. 4.

FIG. 6 is a side view schematically illustrating an example of a loading platform of a truck, which is an example of a motion place used for motion determination in the motion determination system of FIG. 4, together with an example of a forklift.

FIG. 7 is a perspective view schematically illustrating an example of a shelf which is an example of a motion place used for motion determination in the motion determination system of FIG. 4.

FIG. 8 is a flowchart for illustrating an example of a procedure for loading an object from a fork onto a loading platform of a truck in the motion determination system of FIG. 4.

FIG. 9 is a flowchart for illustrating an example of a procedure of picking up an object from a loading platform of a truck to a fork in the motion determination system of FIG. 4.

FIG. 10 is a flowchart for illustrating an example of a procedure for loading an object from a fork onto a loading platform of a truck in a motion determination system according to a second example embodiment.

FIG. 11 is a flowchart for illustrating an example of a procedure of picking up an object from a loading platform of a truck to a fork in the motion determination system according to a third example embodiment.

FIG. 12 is a side view schematically illustrating an example of a loading platform of a truck, which is an example of a motion place used for motion determination in the motion determination system according to a fourth example embodiment, together with an example of a forklift.

FIG. 13 is a side view schematically illustrating an example of a loading platform of a truck, which is an example of a motion place used for motion determination in the motion determination system according to a fifth example embodiment, together with an example of a forklift.

FIG. 14 is a block diagram illustrating a detailed configuration example of a motion determination system according to a sixth example embodiment.

FIG. 15 is a block diagram illustrating a detailed configuration example of a motion determination system according to a seventh example embodiment.

FIG. 16 is a side view schematically illustrating an example of a tunnel, which is an example of a motion place used for motion determination in the motion determination system of FIG. 15, together with an example of a tunnel inspection vehicle.

FIG. 17 is a flowchart for illustrating an example of a procedure for carrying an object to a motion place by a tunnel inspection vehicle in the motion determination system of FIG. 15.

FIG. 18 is a block diagram illustrating a configuration example of an apparatus.

### EXAMPLE EMBODIMENT

Hereinafter, example embodiments will be described in detail with reference to the drawings. Note that in the description and drawings to be described below, omission and simplification are made as appropriate, for clarity of description. In addition, in each of the drawings described below, the same elements and similar elements are denoted by the same reference signs, and a duplicate description is omitted as necessary.

### First Example Embodiment

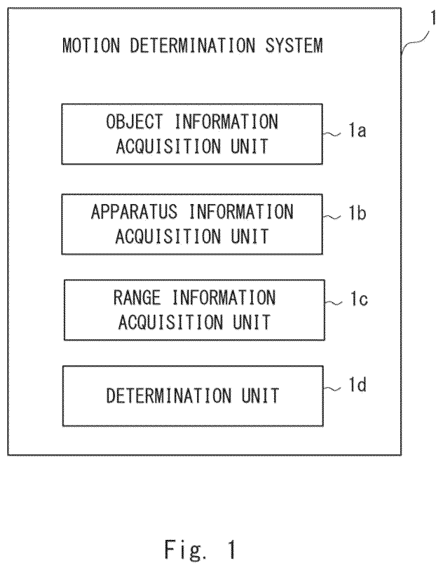

A first example embodiment will be described with reference to FIGS. 1 to 9. First, a configuration and processing according to the present example embodiment will be described with reference to FIGS. 1 to 3. FIG. 1 is a block diagram illustrating a configuration example of a motion determination system according to the present example embodiment.

A motion determination system 1 according to the present example embodiment illustrated in FIG. 1 is a system that determines a motion of a mobile apparatus in a transfer control system that controls the mobile apparatus such as a lift apparatus that conveys an object such as cargo and transfers the object. Note that, in the present disclosure, “transferring” refers to moving and placing an object, and includes at least one of transferring the object from the mobile apparatus to the moving place and transferring the object from the placement place to the mobile apparatus. The transfer control system can also be referred to as a load handling control system.

In the present disclosure, the mobile apparatus can be a mobile apparatus that includes loading means (loading unit) that loads an object and moves the object by loading the object on the loading unit. Here, loading an object can refer to applying a load to the object, such as loading the object, gripping and lifting the object on the lower side of a projection portion or the like of the object, or hanging and lifting the object by hooking a hanging tool on a part of the object. As described above, the loading unit refers to a place where a load of the object is applied, that is, a place where the object is lifted, and can be, for example, a carrying portion (i.e., loading portion) on which the object is carried (i.e., loaded), a support portion that supports the object at a plurality of points, or the like, and can also be referred to as a laden portion.

In a case where the mobile apparatus is a forklift, loading an object on the fork refers to loading the object on the fork, and the loading unit refers to a fork for loading the object. In addition, in a case where the mobile apparatus is a forklift, the object to be conveyed can refer to the cargo loading pallet and the cargo loaded thereon. The cargo loading pallet may include a frame that forms a space for inserting the fork from the horizontal direction. Note that the object to be conveyed without using the cargo loading pallet is the cargo itself.

Although an example other than the forklift will be described later, the mobile apparatus is not limited to an example including the loading unit, and for example, even in a case where the object does not have a projection portion, the mobile apparatus may include a holding unit that holds and lifts the object from both sides.

Note that, in the present disclosure, moving the object between the work parts such as the loading unit and the grip portion means moving and placing the object, and includes at least one of transfer of the object from the mobile apparatus to the moving place and transfer of the object from the placement place to the mobile apparatus.

Hereinafter, a forklift will be described as an example of the mobile apparatus, but the mobile apparatus is not limited thereto, and any apparatus may be used as long as the apparatus conveys the object. In addition, the motion determination system 1 or the transfer control system can also be constructed as a system including a mobile apparatus such as a forklift.

As illustrated in FIG. 1, the motion determination system 1 according to the present example embodiment can include an object information acquisition unit (object information acquisition means) 1a, an apparatus information acquisition unit (apparatus information acquisition means) 1b, a range information acquisition unit (range information acquisition means) 1c, and a determination unit (determination means) 1d.

In the motion determination system 1, the object information acquisition unit 1a, the apparatus information acquisition unit 1b, the range information acquisition unit 1c, and the determination unit 1d can be mounted in a plurality of apparatuses in a distributed manner, and any distribution method thereof is applicable. For example, the motion determination system 1 can include an apparatus including the object information acquisition unit 1a, an apparatus including the apparatus information acquisition unit 1b, an apparatus including the range information acquisition unit 1c, and an apparatus including the determination unit 1d. Each apparatus may include a computer apparatus including hardware including, for example, one or more processors and one or more memories. Then, at least some of functions of the units mounted in each apparatus may be implemented in such a way that one or more processors operate in accordance with a program read from one or more memories.

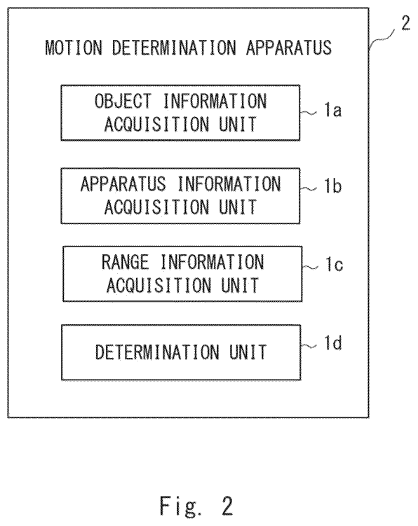

In addition, as illustrated in FIG. 2, the motion determination system 1 can also be constructed as one motion determination apparatus 2 including the object information acquisition unit 1a, the apparatus information acquisition unit 1b, the range information acquisition unit 1c, and the determination unit 1d. FIG. 2 is a block diagram illustrating the motion determination apparatus 2 as a configuration example of the motion determination system 1 of FIG. 1. The motion determination apparatus 2 may be configured as a computer apparatus including hardware including, for example, one or more processors and one or more memories. Then, at least some of functions of the units mounted in the motion determination apparatus 2 may be implemented in such a way that one or more processors operate in accordance with a program read from one or more memories. Further, the motion determination apparatus 2 may be implemented in such a way that the functions of the respective units are distributed to separate apparatuses, and a distribution method thereof is not limited. For example, the motion determination apparatus 2 can include an apparatus including the object information acquisition unit 1a, the apparatus including the apparatus information acquisition unit 1b, the apparatus including the range information acquisition unit 1c, and the apparatus including the determination unit 1d.

Next, the object information acquisition unit 1a, the apparatus information acquisition unit 1b, the range information acquisition unit 1c, and the determination unit 1d will be described. The information handled in each unit 1a can be information managed in a database format.

The object information acquisition unit 1a acquires object information including information regarding the size of an object (conveyance object) conveyed by the mobile apparatus. The object information acquisition unit 1a can acquire the object information at an arbitrary timing before execution of determination by the determination unit 1d described later. Here, the arbitrary timing can be, for example, a timing before the operation of the mobile apparatus, a timing during the movement of the mobile apparatus to the motion place, or a timing at which the mobile apparatus arrives at the motion place. The object information can also be acquired, for example, by reading information such as a barcode or an integrated circuit (IC) tag attached to the object with a scanner, an IC tag reader, or the like. Supplementary details of reading timing will be given. First, in a case where the object is transferred from the mobile apparatus to the moving place, the object information can be read at the time of loading the object on the mobile apparatus at a previous stage, during the movement after the loading, or at the time of arrival at the moving place. On the other hand, in a case where the object is transferred from the placement place to the mobile apparatus, the object information can be read in the placement place. The acquisition source of the object information can be an apparatus that manages the information, and this apparatus can be a storage device provided inside the motion determination system 1 or an external apparatus.

The information regarding the size of the object can be information indicating at least one of a height, a width, and a depth of the object. In addition, the object information can include one or a plurality of pieces of information among, for example, a type of an object such as a product name and an item, a loading condition such that the object cannot be loaded thereon because the object is fragile, a transport destination (destination) of the object, and a transport source (sender) of the object. Of course, the object information may include information other than the exemplified information.

The apparatus information acquisition unit 1b acquires apparatus information that is information regarding a mobile apparatus that moves an object. For example, in a case where the mobile apparatus is a forklift, the apparatus information can be referred to as forklift information. The acquisition source of the apparatus information can be an apparatus that manages the information, and this apparatus can be a storage device provided inside the motion determination system 1 or an external apparatus. Examples of the external apparatus include an apparatus management system that performs management such as allocating a mobile apparatus that conveys an object. In a case where the mobile apparatus is a forklift, examples of the external apparatus include a forklift allocation system that manages allocation of the forklift (allocation of transportation to the forklift).

The apparatus information may include apparatus identification information identifying the mobile apparatus. The apparatus information may also include information indicative of the width of the loading unit and may also include information indicating the length of the loading unit. In this manner, the apparatus information can include information indicating the size of the loading unit. In a case where the mobile apparatus is a forklift, the forklift information may include information indicating the size of the fork portion. Note that, in a case where the motion place to be described later is a place that needs to be moved in a space in which the entire mobile apparatus can be stored, the apparatus information can include information indicating the width of the entire mobile apparatus. In a case where the mobile apparatus is a forklift, this information can be information indicating the entire width. In addition, in a case where the motion place to be described later is a place that needs to be moved in a space in which the entire mobile apparatus can be stored, the apparatus information can include information indicating the length (overall length) of the entire mobile apparatus and information indicating the height. In a case where the mobile apparatus is a forklift, the information indicating the height of the entire forklift can also include information indicating the heights of the head guard and the mast, or the higher one of the heights. The apparatus information may also include operating time information indicating how many hours the mobile apparatus has been operating, remaining fuel information indicating remaining fuel, and the like. In addition, the apparatus information acquisition unit 1b can acquire information (hereinafter, for convenience, it is referred to as static information) that does not change among the apparatus information exemplified above at the arbitrary timing.

The static information of the apparatus information may also include operating time information indicating how many hours the mobile apparatus is operating, remaining fuel information indicating remaining fuel, and the like. These pieces of information can be used, for example, to select a mobile apparatus to be used for transferring the object.

Further, the apparatus information acquisition unit 1b can acquire the motion information as the apparatus information after the operation. The motion information may also be referred to as dynamic information, and the motion information may include information indicating a state of the mobile apparatus after motion. In particular, the motion information can include, for example, lifting height information indicating how much the loading unit is lifted up, and can include length information indicating a length of the loading unit extended in the horizontal direction or a length of the loading unit extended and the contracted in the horizontal direction in a case where the mobile apparatus includes a mechanism for changing the horizontal direction of the loading unit. In a case where the mobile apparatus is, for example, a reach forklift, the latter length information can refer to length information indicating the length of the extended fork or the expansion/contraction length of the reach. The motion information may also include operating time information indicating how many hours the mobile apparatus is operating, remaining fuel information indicating remaining fuel, and the like at the acquisition stage.

The apparatus information acquisition unit 1b can acquire the motion information, for example, at predetermined time intervals. However, the apparatus information acquisition unit 1b can also acquire the motion information as information indicating a state at a stage where a predetermined operation ends. Examples of this stage include a stage where the mobile apparatus moves to a motion place described later. In a case where the mobile apparatus is an apparatus including a loading unit and a lifting or lowering portion for lifting or lowering the loading unit, examples of this stage include a stage where lifting of the loading unit is finished, a stage where lowering of the loading unit is finished, and a stage where the mobile apparatus moves to a motion place described later.

The range information acquisition unit 1e acquires range information indicating a range in which the object can move in the motion place. In addition, the acquisition source of the range information can be an apparatus that manages the information, and this apparatus can be a storage device provided inside the motion determination system 1 or an external apparatus.

Examples of the motion place include, but are not limited to, a shelf, a loading platform of a truck, and the like. In the present disclosure, a “motion place” refers to a place where an object is transferred, and refers to a place where a motion of transferring the object with a mobile apparatus is executed. Here, the motion of transferring the object by the mobile apparatus can refer to a motion of dropping off or picking up the object by the mobile apparatus. As described above, the “motion place” refers to the motion place in the case of transferring the object from the mobile apparatus such as the forklift to the moving place, and refers to the placement place in the case of transferring the object from the placement place to the mobile apparatus such as the forklift.

The range information acquisition unit 1c also acquires place information indicating the motion place as a part of the range information or as information different from the range information. However, the range information acquisition unit 1c only needs to be able to acquire place information in order to move to the motion place and obtain range information, and acquire range information for determination by the determination unit 1d. Therefore, the range information acquisition unit 1c can be configured to first acquire place information and acquire range information corresponding to the acquired place information. The acquisition source of the place information can be an apparatus that manages the information, and this apparatus can be a storage device provided inside the motion determination system 1 or an external apparatus.

In a case where the motion place is a loading platform of a truck, the place information can include, as information for specifying the truck, any one or both of truck identification information such as a license plate and truck feature information indicating features of the appearance of the truck. The information for specifying the truck can be managed in a truck allocation management system provided in or connected to the motion determination system 1. In a case where the motion place is a shelf, the place information can include any one or both of shelf identification information such as a shelf number and location information indicating a position of the shelf as information for specifying the shelf. The location information may be information indicating a number tag attached to each shelf. The information for specifying the shelf can be managed in a warehouse management system provided in or connected to the motion determination system 1.

In addition, the range information indicates a range in which an arbitrary object can move in the motion place regardless of the object, and is referred to by the determination unit 1d to determine whether the object can be transferred within the range indicated by the range information. Therefore, it can be said that the range information is condition information indicating a condition for moving an arbitrary object at the motion place. In addition, in a case where the motion place is a loading platform of a truck, in a case where there is no ceiling on the loading platform, the height in the range information may be a legal height when the truck travels on a road.

The range information in the case of placing (dropping off) the object at the moving place by the mobile apparatus is information indicating a range (loadable range) in which the object can be placed at the moving place scheduled as the placement place or added as a candidate, and thus can be referred to as loadable range information. The loadable range information can include, for example, information indicating how high the object may be loaded at the motion place, which is a planned or candidate moving place.

The range information in the case of picking up the object from the current placement place by the mobile apparatus is information indicating a range in which the object can be taken out (loaded and unloaded, and the like) from the current placement place, and thus can be referred to as retrievable range information. The retrievable range information can include information indicating how high the object may be lifted at the motion place that is the current placement place.

In a case where the motion place is a loading platform of a truck, the range information may include height information of a bottom surface of the loading platform, ceiling height information indicating a ceiling height of the loading platform, width information indicating a width of the loading platform, and depth information indicating a depth of the loading platform for the truck. The range information in this case may be information associated with truck identification information, a vehicle type, a carrier, and the like.

In a case where the motion place is a shelf, the range information may include height information indicating a height of a bottom surface, height information indicating a height of a top surface, width information indicating a width, and depth information indicating a depth for the shelf. The range information in this case may be information associated with a shelf number. Note that, in a case where the shelf is a shelf in which the region is divided, such as a case where the shelf includes at least one of a plurality of stages and a plurality of columns, the range information can include the following information. That is, the range information can include height information indicating the height of the bottom surface, height information indicating the height of the top surface, width information indicating the width, and depth information indicating the depth for each storage area in the shelf. The range information in this case may be information associated with the number of each storage area of the shelf.

Then, the determination unit 1d determines whether the transfer motion (dropping off or picking up) for the object can be executed at the motion place according to the object information, the apparatus information, and the range information as described above. Whether the motion is executable can refer to whether the object is transferrable without collision at the motion place. For example, the determination unit 1d can determine whether the mobile apparatus will collide with the periphery of the moving place using the object information, the apparatus information, and the range information even in a case where the mobile apparatus executes a motion of lifting or lowering the object at the moving place.

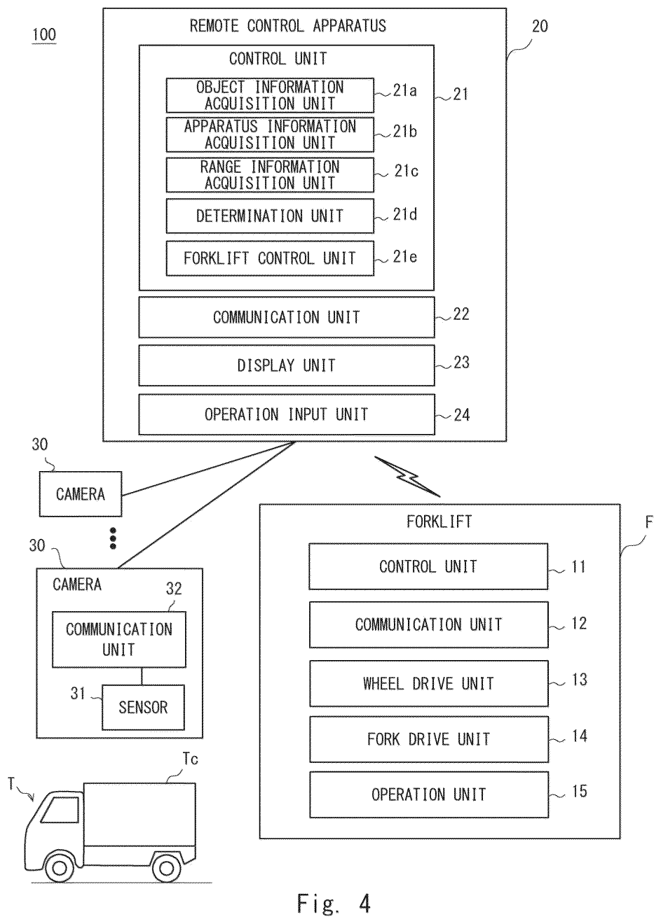

In the determination unit 1d, each piece of information used for the determination can be acquired at least before the determination, for example, before the motion of the mobile apparatus, as described above. However, as described above, the motion information in the apparatus information can be acquired every predetermined time or every time the operation at a predetermined stage is completed. Specific examples of the determination unit 1d and each piece of information used for the determination will be described later with reference to FIG. 4 and subsequent drawings.

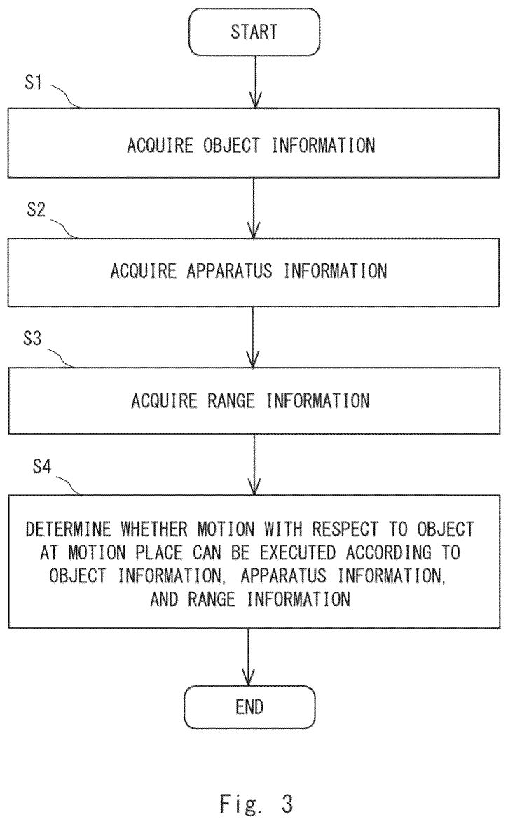

Next, a motion determination method in the motion determination system 1 or the motion determination apparatus 2 having the above-described configuration will be described with reference to FIG. 3. FIG. 3 is a flowchart for illustrating an example of the above motion determination method.

In this motion determination method, the object information acquisition unit 1a acquires object information including information regarding a size of an object (step S1). Next, the apparatus information acquisition unit 1b acquires apparatus information that is information regarding a mobile apparatus that moves an object (step S2). Next, the range information acquisition unit 1c acquires range information indicating a range in which an object can be moved at a motion place which is a place where a motion of transferring the object by the mobile apparatus is executed (step S3). Note that the order of steps S1 to S3 is not limited, and two or more steps may be executed simultaneously. Finally, the determination unit 1d determines whether the motion of transferring the object is able to be executed on the object at the motion place according to the object information, the apparatus information, and the range information (step S4).

As described above, according to the present example embodiment, since the determination is performed using the apparatus information as the information for determination, it is possible to perform the determination for safely transferring the object by the mobile apparatus. That is, according to the present example embodiment, the object can be transferred in consideration of safety.

On the other hand, in a case where the present example embodiment is not adopted, for example, in a scene where the size is limited such as a shelf and a truck, special attention is required, and even in a case where it is determined that the cargo itself can be placed, it may not be possible to place the cargo depending on the size of the mobile apparatus. On the other hand, in a case where it is confirmed whether placement is possible by visual observation, since a blind spot may be caused by cargo and visibility may be deteriorated, it takes time and effort, and visual observation may be erroneously performed. Therefore, for visual confirmation, at least a skilled technique is required to compensate for the blind spot portion, and it cannot be said that safety can be ensured. In addition, not only in a case where cargo is placed, that is, in a case where the cargo is dropped off, but also in a case where cargo is picked up, a similar problem may occur. However, in the present example embodiment, as described above, the object can be transferred in consideration of safety.

Next, a specific example of the determination unit 1d and each piece of information used for determination, that is, a detailed configuration example of the motion determination system 1 of FIG. 1 will be described with reference to FIGS. 4 to 9. In the following description, a forklift is exemplified as the mobile apparatus, but the following description can also be applied to other types of mobile apparatuses.

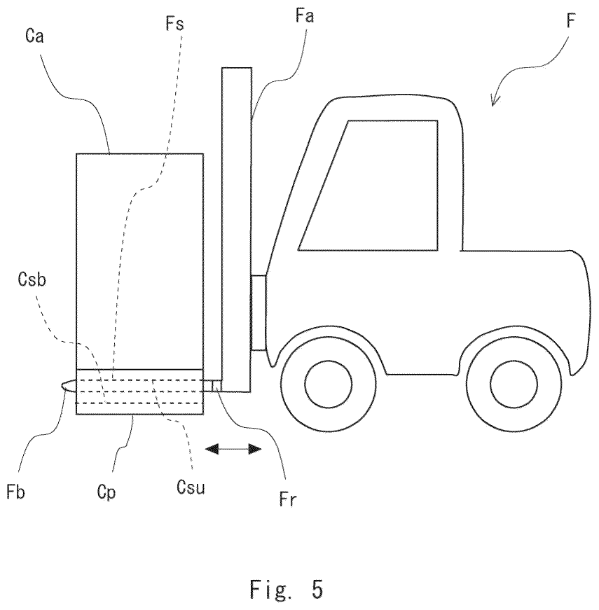

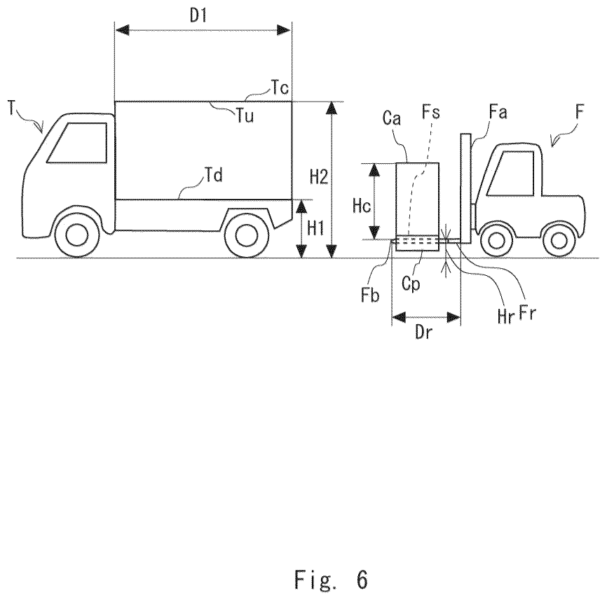

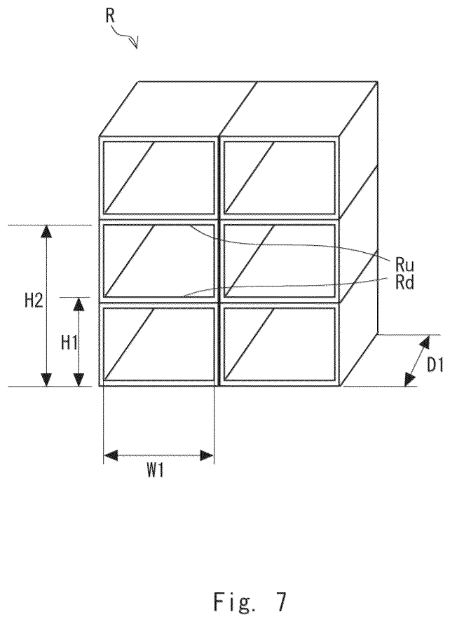

First, an overview of this configuration example will be described with reference to FIGS. 4 to 7. FIG. 4 is a block diagram illustrating a detailed configuration example of the motion determination system 1 of FIG. 1. FIG. 5 is a side view schematically illustrating an example of a forklift that is a control target of a motion determination in the motion determination system 100 of FIG. 4. FIG. 6 is a side view schematically illustrating an example of a loading platform of a truck, which is an example of a motion place used for motion determination in the motion determination system 100 of FIG. 4, together with an example of a forklift. FIG. 7 is a perspective view schematically illustrating an example of a shelf which is an example of a motion place used for motion determination in the motion determination system 100 of FIG. 4.

The motion determination system 100 illustrated in FIG. 4 can include one or a plurality of forklifts F, a remote control apparatus 20 which is an example of the motion determination apparatus 2, and one or a plurality of cameras 30. In addition, a truck T in FIG. 4 is a truck having a loading platform Tc as a transfer destination or a transfer source exemplified herein, and the transfer destination or the transfer source may be a shelf or the like instead of the truck T.

A camera 30 used for remote operation is connected to the remote control apparatus 20 in a wired or wireless manner. The type of network for connection is not particularly limited. The network for performing wireless connection can be, for example, a network such as 3rd generation (3G), long term evolution (LTE), 4G, 5G, or local 5G, or a wireless local area network (LAN) (for example, Wi-Fi (registered trademark)). Furthermore, the network for performing wired connection can be, for example, a wired LAN.

Furthermore, the camera 30 can be installed at one or a plurality of positions, and may be installed at a high position on a ceiling or a wall as long as it is indoors, or may be installed at a high position on a pole or an outer wall of a building as long as it is outdoors, but may be installed in a forklift regardless of whether it is indoors or outdoors. The camera 30 can be a visible light camera. The camera 30 can also have a distance measurement function for grasping a position such as a height at the time of remote operation, and can be a 3D camera or the like in the case of a visible light camera. The camera 30 may be, for example, a laser sensor such as LiDAR (registered trademark) or an infrared time-of-flight (ToF) camera. The camera 30 can include a sensor 31 such as a light receiving element, and a communication unit 32 that transmits sensor data detected by the sensor 31 or distance data calculated therefrom to the remote control apparatus 20.

In addition, one or a plurality of forklifts F are wirelessly connected to the remote control apparatus 20 as a control target. Hereinafter, one forklift F will be described as a control target, but other forklifts can be similarly controlled. The remote control apparatus 20 can also be referred to as a control apparatus.

The forklift F can include a control unit 11, a communication unit 12 that performs wireless communication with the remote control apparatus 20, a wheel drive unit 13 that drives the wheel, a fork drive unit 14 that drives the fork, and an operation unit 15. The control unit 11 can control the communication unit 12, the wheel drive unit 13, the fork drive unit 14, and the operation unit 15, and cooperates the respective portions as necessary to implement the function of the forklift F.

The control unit 11 may be configured as a computer apparatus including hardware including, for example, one or more processors and one or more memories. Then, at least some of functions of the units mounted in the forklift F may be implemented in such a way that one or more processors operate in accordance with a program read from one or more memories. Note that the communication unit 12 can also be configured to be directly wirelessly connected to the camera 30.

As illustrated in FIG. 5, the forklift F can include a lift portion Fa which is a part of the fork drive unit 14, a fork Fb which is attached so as to be movable up and down by the lift portion Fa, and an expansion/contraction portion Fr which is a part of the fork drive unit 14 on the front side of the main body. The lift portion Fa can be configured by, for example, a lift cylinder, a lift chain, or the like, but various existing mechanisms can be applied. The expansion/contraction portion Fr is a portion connecting the fork Fb and the lift portion Fa, and includes a mechanism for moving the fork Fb in the horizontal direction such that the distal end of the fork Fb extends and contracts in the horizontal direction (the front-rear direction of the forklift F) indicated by a double-headed arrow in FIG. 5 with respect to the lift portion Fa. This mechanism may have any structure or the like as long as it is a mechanism capable of such expansion and contraction. In addition, the arrangement of the expansion/contraction portion Fr is not limited thereto, and for example, the expansion/contraction portion Fr can be provided between the lift portion Fa and the main body of the forklift F.

The fork drive unit 14 can include a driving source that drives the lift portion Fa, the fork Fb, and the expansion/contraction portion Fr, a circuit that receives a control signal from the control unit 11 and drives the driving source, and the like, in addition to the lift portion Fa, the fork Fb, and the expansion/contraction portion Fr. Examples of the driving source include a driving source such as a motor or an engine that provides power to raise and lower the fork Fb with respect to the lift portion Fa, and a driving source such as a motor or an engine that provides power to expand and contract the expansion/contraction portion Fr. These driving sources can be provided, for example, on the main body side of the forklift F. In FIG. 5, the fork Fb can have a loading surface Fs serving as a surface on which the cargo loading pallet Cp, which is a part of the object, is loaded.

The cargo loading pallet Cp includes an upper frame, a lower frame, and a pair of side surface frames connecting the upper frame and the lower frame, and can form one or a plurality of spaces. By inserting the fork Fb into this space, it is possible to load an object including the cargo loading pallet Cp, that is, the cargo loading pallet Cp and the cargo Ca loaded thereon in the example of FIG. 5. When the fork Fb loads and lifts the object, the lower surface Csu of the upper frame comes into contact with the loading surface Fs. The upper surface Csb of the lower frame is a surface that comes into contact with the lower surface of the fork Fb when the fork Fb is lowered to the lower side. However, some of the cargo loading pallets do not include the lower frame.

The wheel drive unit 13 can include a circuit for driving wheels for moving the entire forklift F in response to a control signal from the control unit 11. As described above, the fork drive unit 14 can include the lift portion Fa, the expansion/contraction portion Fr, the driving source, a circuit for driving the driving source, and the like.

The operation unit 15 is an operation unit that receives a driving operation in a case of manually driving the forklift F, and can include, for example, a physical mechanism such as a steering wheel or a lever, and a circuit that reads out the driving operations performed by those physical mechanisms and passes them to the control unit 11. An attachment including an actuator that enables automatic driving can be attached to the operation unit 15. In that case, the control unit 11 can control the actuator via the communication unit 12 or the like to operate the operation unit 15 to enable automatic driving. In a case where the forklift F is a forklift dedicated to autonomous movement, the operation unit 15 is unnecessary.

In addition, the forklift F is a forklift including the expansion/contraction portion Fr, and it is a forklift whose fork Fb expands and contracts in the horizontal direction and is referred to as a reach forklift. However, the forklift can be a counter forklift in which the position of the fork Fb in the horizontal direction is fixed.

The remote control apparatus 20 can include a control unit 21, a communication unit 22 that communicates with the camera 30 and the forklift F, a display unit 23 that displays an operation image for remote operation, and an operation input unit 24 that operates the operation image. The control unit 21 can control the communication unit 22, the display unit 23, and the operation input unit 24, and achieves the function of the remote control apparatus 20 by linking the respective components as necessary.

The control unit 21 can include an object information acquisition unit 21a, an apparatus information acquisition unit 21b, a range information acquisition unit 21c, and a determination unit 21d corresponding to the object information acquisition unit 1a, the apparatus information acquisition unit 1b, the range information acquisition unit 1c, and the determination unit 1d, respectively. In addition, the control unit 21 may include a forklift control unit 21e for controlling the forklift F. The control unit 21 may be configured as a computer apparatus including hardware including, for example, one or more processors and one or more memories. Then, at least some of functions of the units mounted in the remote control apparatus 20 may be implemented in such a way that one or more processors operate in accordance with a program read from one or more memories.

The object information acquisition unit 21a acquires object information including information regarding the size of an object (here, the cargo loading pallet Cp and the cargo Ca) conveyed by the forklift F. The acquisition source of the object information can be, for example, a storage device inside the remote control apparatus 20, an external cargo management system connected to the remote control apparatus 20 via the communication unit 22, or the like. In a case where the forklift F saves information regarding the object currently loaded on the fork Fb, the object information acquisition unit 21a can also acquire the object information from the forklift F. Hereinafter, an example in which the information regarding the size of the object is information indicating the upper frame of the cargo loading pallet Cp and the height of the cargo Ca will be described.

The apparatus information acquisition unit 21b acquires forklift information that is information regarding the forklift F that moves the object. The acquisition source of the forklift information may be, for example, a storage device inside the remote control apparatus 20, the forklift F connected to the remote control apparatus 20 via the communication unit 22, a vehicle allocation (vehicle allocation of the forklift) management system, or the like.

Hereinafter, in order to simplify the description, an example in which not only the forklift F that conveys the object but also the truck T or the shelf is determined in advance will be described as an example, but the present disclosure is not limited thereto. In addition, in this example, for simplification of description, it is assumed that the forklift information does not include the static information described above but includes only the motion information. That is, the forklift information here does not include information indicating the width and length of the forks Fb, and the description will be given assuming that the width of the loading platform Tc as the motion place is larger than the width of the forks Fb and the depth of the loading platform Tc is longer than the length of the forks Fb. In addition, here, an example in which the loading platform Tc is a place that does not need to be moved in a state of housing the entire forklift F, and only a fork Fb of the forklift F is dropped off or picked up will be described.

The apparatus information acquisition unit 21b in this example acquires the motion information as the forklift information from the forklift F via the communication unit 22 at predetermined time intervals after the motion, for example. The motion information can include information indicating a state of the forklift F after the motion. In particular, the motion information can include, for example, lifting height information indicating how much the fork Fb is lifted up, and can include length information indicating the length of the fork Fb extended by the expansion/contraction portion Fr or the length of the reach as a result of the extension.

The range information acquisition unit 21c acquires place information indicating the motion place, and acquires range information corresponding to the acquired place information. The range information is information indicating a range in which the object can move in the motion place. The acquisition source of the place information and the range information may be, for example, a storage device inside the remote control apparatus 20 or a system connected to the remote control apparatus 20 via the communication unit 22. This system corresponds to a truck allocation management system in a case where the transfer source or the transfer destination is the truck T, and corresponds to a warehouse management system in a case where the transfer source or the transfer destination is a shelf.

In a case where the motion place is the truck T, the place information can include, as information for specifying the truck T, any one or both of truck identification information such as a license plate and truck feature information indicating features of the appearance of the truck. In a case where the motion place is a shelf, the place information can include any one or both of shelf identification information such as a shelf number and location information indicating a position of the shelf as information for specifying the shelf. The location information may be information indicating a number tag attached to each shelf.

The range information in the case of placing (dropping off) the object at the moving place by the forklift F is loadable range information indicating a range (loadable range) in which the object can be placed at the placement place scheduled as the placement place or added as a candidate. The loadable range information can include, for example, information indicating how high the object may be loaded at the motion place, which is a planned or candidate moving place.

The range information in the case of picking up the object from the current placement place by the forklift F is retrievable range information indicating a range in which the object can be taken out (loaded and unloaded, and the like) from the current placement place. The retrievable range information can include information indicating how high the object may be lifted at the motion place that is the current placement place.

As illustrated in FIG. 6, a case where the motion place is the loading platform Tc of the truck T will be described. In this case, the range information can include, for the truck T, bottom height information indicating the height H1 of the lower surface (bottom surface) Td of the loading platform, ceiling height information indicating the height H2 of the ceiling Tu of the loading platform Tc, width information indicating the width of the loading platform Tc, and depth information indicating the depth Dt of the loading platform Tc. Note that the width of the loading platform Tc is a length of a loadable portion of the loading platform Tc in a direction perpendicular to the plane of drawing of FIG. 6. The range information in this case may be information associated with truck identification information, a vehicle type, a carrier, and the like. Further, the loading platform Tc can be formed of a housing in which one surface or two surfaces of one surface and a surface facing the one surface can be opened, but may have a frame configuration.

As illustrated in FIG. 7, a case where the motion place is the storage area on the second left row of the shelf R will be described. In this case, the range information can include height information indicating the height H1 of the bottom surface Rd, height information indicating the height H2 of the upper surface Ru, width information indicating the width W1, and depth information indicating the depth D1 for the storage area. The range information in this case may be information associated with the shelf number and the storage area number. Note that the shelf R and the storage area thereof can be configured by a housing in which one surface or two surfaces of one surface and a surface facing the one surface can be opened, but may have a frame configuration.

Then, the determination unit 21d determines whether a transfer motion (motion of dropping off or picking up) for the object is executable at the motion place according to the object information, the forklift information, and the range information. As described above for the determination unit 1d, in the determination unit 21d, each piece of information used for determination can be acquired before determination such as before the forklift operation, but the motion information can be acquired every predetermined time or every time the motion in a predetermined step is completed.

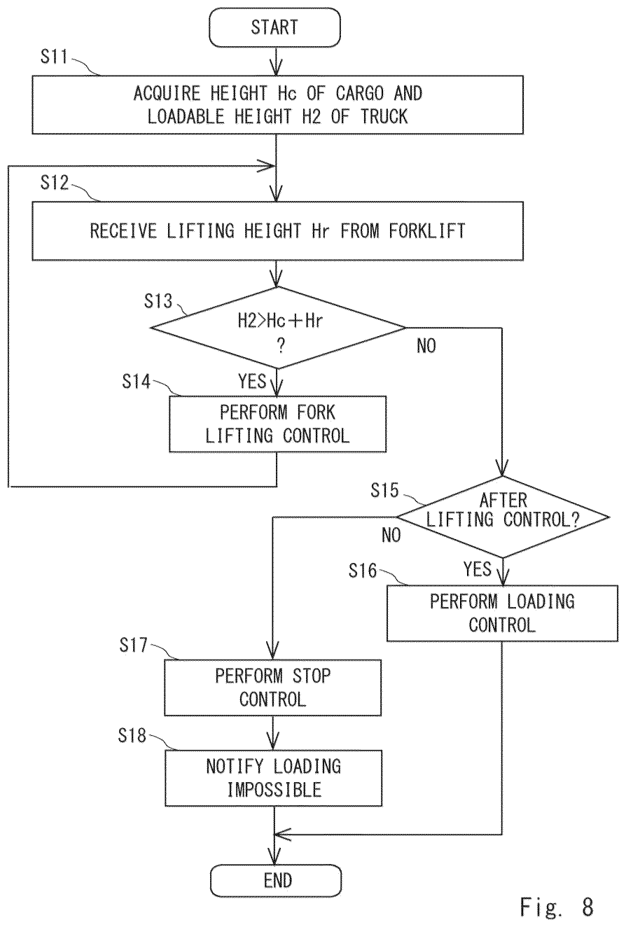

Next, an example of a procedure of dropping off (drop-off) an object from the fork Fb at a dropping off place that is a motion place will be specifically described with reference to FIG. 8 mainly together with FIGS. 4 and 6. A scene where the object is dropped off from the fork Fb (hereinafter, scene A) refers to a case where the fork Fb transfers the object to the transfer place.

FIG. 8 is a flowchart for illustrating an example of a procedure of loading an object by dropping off the object from the fork Fb of FIG. 6 to the loading platform Tc of the truck T of FIG. 6 in the motion determination system 100 of FIG. 4. Note that, for simplification of description, description of transmission and reception of information via the communication unit 12, the communication unit 22, and the communication unit 32 will be omitted below. In addition, in the following, in order to simplify the description, processing from a state where the fork Fb is at the bottom of the movable range will be described.

In the scene A where the object is dropped off from the fork Fb, first, an operation of an installation instruction of the object on the truck T by the forklift F is received from the operation input unit 24 of the remote control apparatus 20. The installation instruction includes an instruction for executing installation.

The installation instruction can include, for example, an instruction to designate the object, the truck T as the installation place, and the forklift F to be installed, and these instructions can be received before determination by the determination unit 21d. When the operation of the installation instruction is received, the object information acquisition unit 21a and the range information acquisition unit 21c acquire information (step S11). In step S11, the object information acquisition unit 21a and the range information acquisition unit 21c respectively acquire information indicating the height Hc of the object (the upper frame of the cargo Ca and the cargo loading pallet Cp) and information indicating the loadable height H2 of the truck T.

Note that the object information acquisition unit 21a can obtain the height Hc of the object by acquiring information indicating the height of the cargo Ca and adding the thickness of the upper frame of the cargo loading pallet Cp stored in advance to the height. Alternatively, the object information acquisition unit 21a can manage a value obtained by adding the thickness of the upper frame of the cargo loading pallet Cp in advance as the height Hc of the cargo Ca and acquire information indicating the height Hc of the object.

Next, the apparatus information acquisition unit 21b requests the forklift F to provide information indicating the lifting height Hr of the fork Fb, and acquires information indicating the lifting height Hr of the fork Fb from the forklift F (step S12). The lifting height Hr in this example indicates the height of the upper surface of the fork Fb. In addition, the order of steps S11 and S12 is irrelevant as long as the information has been acquired at the stage of step S13 described later, such as executing step S11 after step S12. That is, the timing of acquiring various types of information used for determination by the determination unit 21d is not limited to the timing described in steps S11 and S12, and may be any timing before determination by the determination unit 21d.

Next, the determination unit 21d determines whether the loadable height H2 of the truck T is greater than the sum of the height Hc of the object (the upper frame of the cargo Ca and the cargo loading pallet Cp) and the lifting height Hr (step S13). With this determination, it is possible to determine whether the head (upper surface) of the cargo Ca is rubbed against the ceiling Tu of the loading platform Tc of the truck T. Note that, in a case where step S14 to be described later has never been performed, the lifting height Hr of the fork Fb acquired in a state where the fork Fb is at the bottom of the movable range is used for the determination.

If YES in step S13, the forklift control unit 21e performs lifting control to lift the fork Fb of the forklift F (step S14), and the processing returns to step S12. In the forklift F subjected to the lifting control, the control unit 11 drives the fork drive unit 14 to control the lifting of the fork Fb, and the fork Fb is lifted. Note that the processing from the state where the fork Fb is at the bottom of the movable range will be described. However, regardless of the height of the fork Fb when the object is conveyed, whether the fork Fb performs lifting control or lowering control may be determined based on the height and the height of the bottom surface Td of the loading platform Tc of the truck T.

In step S13 after step S14, the determination is made using the height after the lifting of the fork Fb is controlled as the lifting height Hr of the fork Fb.

On the other hand, if NO in step S13, the forklift control unit 21e determines whether it is after the lifting control in step S14 (step S15). If YES in step S15, the forklift control unit 21e executes the movement control of the forklift F to a position where transfer (dropping off in this example) can be performed with respect to the motion place (dropping off in this example), and also executes extension control of the expansion/contraction portion Fr as necessary. Then, the forklift control unit 21e executes the loading control (dropping off control) at the stage of reaching the motion place in this manner (step S16), and ends the processing. The dropping off control can include lowering control of the fork Fb and at least one of movement control for pulling out the fork Fb and shortening control of the expansion/contraction portion Fr.

In the present disclosure, a method of controlling actual loading (dropping off) at a motion place is not limited. For example, the operator can execute loading of the object by sequential remote operation from the operation input unit 24 while confirming an image obtained by the camera 30, a camera (not illustrated) mounted on the forklift F, and the like. Alternatively, it is also possible to perform control such that automatic loading is performed by the operator performing the loading execution operation at the stage of being positioned at the motion place. Alternatively, without requiring such a loading execution operation, it is possible to automatically determine that it is positioned at the motion place and perform control to automatically perform loading. Further, in the present disclosure, a method for moving the mobile apparatus such as the forklift F after the dropping off is not limited.

On the other hand, if NO in step S15, the forklift control unit 21e performs stop control to stop the motion related to the loading of the object onto the truck T by the forklift F (step S17). Thereafter, the control unit 21 notifies the administrator or the like of the determination result indicating that the loading is impossible (step S18), and ends the processing. The administrator or the like can receive the notification at the terminal apparatus, for example. This determination result indicates a result of determination that a collision will occur. In addition, the determination unit 21d determines whether there is an operation method that does not cause a collision, and in a case where there is the operation method, information indicating such an operation method may be included in this notification in order to guide the operation by the driver or the remote operator. The information indicating the operation method can include, for example, information indicating an operation of only pulling out the fork Fb, an operation of only raising, an operation of only lowering, and the like, and can also include information indicating to what extent the fork Fb may be raised or lowered (information indicating an operation amount). Note that the order of steps S17 and S18 is not limited.

In addition, the processing example of FIG. 8 can be started, for example, in a scene where the movement of the forklift F is designated by operation from the operation input unit 24 of the remote control apparatus 20, and the forklift control unit 21e generates a command according to the designation and transmits the command to the forklift F. Upon receiving the command, the control unit 11 controls the wheel drive unit 13 to move in accordance with the command, and the forklift F reaches the vicinity of the truck T. Alternatively, the processing example of FIG. 8 can be started in a scene where the forklift F reaches the vicinity of the truck T in this manner.

When the forklift F has a function of acquiring position information, the forklift F can automatically move to the vicinity of the truck T. Alternatively, the operator can cause the forklift F to reach the vicinity of the truck T by sequential remote operation from the operation input unit 24 while checking an image obtained by the camera 30, a camera (not illustrated) mounted on the forklift F, and the like. The present disclosure is not limited to this, and in the present disclosure, the description thereof is omitted, but the forklift F may be moved by any control to reach the destination.

In addition, the above description is based on the premise that the processing is performed from the state where the fork Fb is at the bottom of the movable range, but the present invention is not limited thereto and can be applied. For example, even in a case where the processing is started from a state where the fork Fb is located on the uppermost side of the movable range thereof or a state where the fork Fb is placed above the ceiling Tu of the loading platform Tc, the processing of step S13 can be applied to the determination processing of “H2>Hc+Hr” by performing the following replacement. That is, the present invention can be applied by replacing the lifting control in steps S14, S15, and the like with the lowering control and replacing step S18 with the dropping off end notification.

As described above, in the processing example of FIG. 8 described with reference to FIG. 6, a scene in which the object is dropped off to the loading platform Tc of the truck T has been described, but the present invention can be similarly applied to a scene in which the object is dropped off to the shelf R as illustrated in FIG. 7.

In addition, in the processing example of FIG. 8, an application example in which the processing in which steps S15 and S16 are removed, that is, the processing of proceeding to step S17 in the case of NO in step S13 is performed can also be adopted. In this application example, the lifting height Hr can also be designated in the first command, so that it can be determined whether the object can be loaded according to the command. Then, if the loading is impossible, the operator may perform an operation of correcting the lifting height Hr and obtain the determination result again.

In addition, in the processing example of FIG. 8, instead of the lifting height Hr, an application example in which a range of the lifting height (changeable range of the lifting height Hr) is used for determination can also be adopted. In this application example, when the height higher than Hc+Hr exists in the above-described changeable range in the determination by the determination unit 21d, it is possible to permit the loading of the object on the truck T and execute the control for the loading. On the other hand, in a case where such a height does not exist, the loading is not permitted, and notification to the administrator or the like or stop of control in a case where control is being performed may be executed.

In addition, in the processing example of FIG. 8 described with reference to FIG. 6 and the above-described application example, the scene A in which the object is dropped off on the loading platform Tc of the truck T has been described, but the present example embodiment can also be applied to a scene (scene B) in which the object is picked up from the loading platform Tc of the truck T.

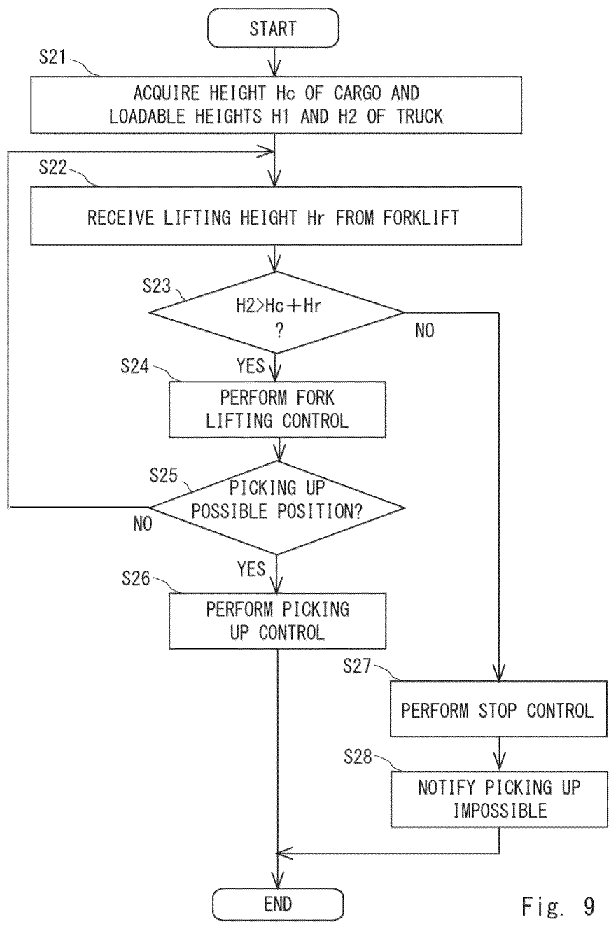

The scene B in which the object is picked up from the loading platform Tc of the truck T will be described with reference to FIG. 9. FIG. 9 is a flowchart for illustrating an example of a procedure of picking up an object from the loading platform Tc of the truck T to the fork Fb in the motion determination system 100 of FIG. 4. In addition, in order to simplify the description, processing from a state in which the fork Fb is at the bottom of the movable range will be described below, but the present invention is not limited thereto.

After the processing example of FIG. 9 described below is performed, the state illustrated in FIG. 6 is obtained. Although the state before the processing example of FIG. 9 is executed is not illustrated, it is a state in which the cargo Ca and the cargo loading pallet Cp, which are the objects in FIG. 6, are loaded on the loading platform Tc.

First, an operation of a picking up instruction of an object from the truck T by the forklift F is received from the operation input unit 24 of the remote control apparatus 20. The picking up instruction includes an instruction to execute the picking up. The picking up instruction may include, for example, an instruction to designate an object, the truck T as a picking up place, and the forklift F to perform pickup, and these instructions can be received before determination by the determination unit 21d. When the operation of the picking up instruction is received, the object information acquisition unit 21a and the range information acquisition unit 21c acquire information (step S21). In step S21, the object information acquisition unit 21a and the range information acquisition unit 21c respectively acquire information indicating the height Hc of the object (the upper frame of the cargo Ca and the cargo loading pallet Cp) and information indicating the loadable range of the truck T. The loadable range can be expressed by heights H1 and H2 in the height direction. The height H1 is acquired in order to calculate a picking up possible position.

Next, the apparatus information acquisition unit 21b requests the forklift F to provide information indicating the lifting height Hr of the fork Fb, and acquires information indicating the lifting height Hr of the fork Fb from the forklift F (step S22). The lifting height Hr in this example indicates the height of the upper surface of the fork Fb. In addition, the order of steps S21 and S22 is irrelevant as long as the information has been acquired at the stage of step S23 described later, such as executing step S11 after step S22.

Next, the determination unit 21d determines whether the loadable height H2 of the truck T is greater than the sum of the height Hc of the object and the lifting height Hr (step S23). With this determination, it is possible to determine whether the head (upper surface) of the cargo Ca is rubbed against the ceiling Tu of the loading platform Tc of the truck T.

If YES in step S23, the forklift control unit 21e performs lifting control to lift the fork Fb of the forklift F (step S24), and determines whether the forklift F has reached the picking up possible position (step S25). Note that the determination in step S25 can be performed before the lifting control in step S24.

The determination in step S25 can be executed based on the loadable height H1 acquired in step S21, the lifting height Hr acquired in step S22, and the size information of the cargo loading pallet Cp stored in advance. Referring to FIG. 5, the size information may include a thickness of the lower frame and a distance from the upper surface Csb of the lower frame to the lower surface Csu of the upper frame. When the lifting height Hr is larger than the sum of the loadable height H1 and the thickness of the lower frame and smaller than the sum of the loadable height H1, the thickness of the lower frame, and the distance, it can be determined that the fork Fb is at a position where the fork Fb can be inserted into the cargo loading pallet Cp of the fork Fb.

If NO in step S25, the processing returns to step S12. In the forklift F subjected to the lifting control in step S24, similarly to the example described in step S14, the control unit 11 drives the fork drive unit 14 to control the lifting of the fork Fb, and the fork Fb is lifted.

If YES in step S25, the forklift control unit 21e executes the movement control of the forklift F to a position where transfer (picking up in this example) can be performed with respect to the motion place (picking up place in this example), and executes the extension control of the expansion/contraction portion Fr as necessary. Then, when the forklift control unit 21e reaches the motion place in this manner, the picking up control is executed (step S26), and the processing ends. The picking up control can include at least one of movement control for insertion of the fork Fb and extension control of the expansion/contraction portion Fr, and lifting control of the fork Fb.

In the present disclosure, an actual method of controlling the picking up at the motion place does not matter. For example, the operator can execute picking up of the object by sequential remote operation from the operation input unit 24 while confirming an image obtained by the camera 30, a camera (not illustrated) mounted on the forklift F, and the like. Alternatively, it is also possible to perform control such that automatic picking up is performed by the operator performing the picking up execution operation at the stage of being positioned at the motion place. Alternatively, without requiring such a picking up execution operation, it is possible to automatically determine that it is positioned at the motion place and perform control to automatically perform picking up. Further, in the present disclosure, a method for moving the mobile apparatus such as the forklift F after the picking up is not limited.

On the other hand, if NO in step S23, the forklift control unit 21e performs stop control to stop the motion related to the picking up of the object from the truck T by the forklift F (step S27). Thereafter, the control unit 21 notifies the administrator or the like of the determination result indicating that the picking up loading is impossible (step S28), and ends the processing. The administrator or the like can receive the notification at the terminal apparatus, for example. This determination result indicates a result of determination that a collision occurs. In addition, the determination unit 21d determines whether there is an operation method that does not cause a collision, and in a case where there is the operation method, information indicating such an operation method may be included in this notification in order to guide the operation by the driver or the remote operator. The information indicating the operation method can include, for example, information indicating an operation of only inserting the fork Fb, an operation of only raising, an operation of only lowering, and the like, and can also include information indicating to what extent the fork Fb may be raised or lowered (information indicating an operation amount). Note that the order of steps S27 and S28 is not limited.

In addition, the processing example of FIG. 9 can be started in a scene where a command of the movement operation is transmitted to the forklift F or a scene where the forklift F has reached the vicinity of the truck T, similarly to the processing example of FIG. 8.

In addition, the above description is based on the premise that the processing is performed from the state where the fork Fb is at the bottom of the movable range, but the present invention is not limited thereto and can be applied. For example, even in a case where the processing is started from a state where the fork Fb is located on the uppermost side of the movable range thereof or a state where the fork Fb is placed above the ceiling Tu of the loading platform Tc, the processing of step S23 can be applied to the determination processing of “H2>Hc+Hr” by performing the following replacement. That is, it can be applied by replacing the lifting control such as step S24 with the lowering control and replacing step S28 with the picking up end notification.

In addition, in the processing example of FIG. 9, a scene in which the object is picked up from the loading platform Tc of the truck T has been described, but the present invention can be similarly applied to a scene in which the object is picked up from the shelf R as illustrated in FIG. 7.

In addition, in the processing example of FIG. 9, it is also possible to adopt an application example in which steps S24 to S26 are removed and processing of notifying the administrator or the like that picking up is possible in a case of YES in step S23 is executed. In this application example, the lifting height Hr can also be designated in the first command, so that it can be determined whether the object can be picked up according to the command. Then, if the picking up is impossible, the operator may perform an operation of correcting the lifting height Hr and obtain the determination result again.

In addition, in the processing example of FIG. 9, instead of the lifting height Hr, an application example in which a range of the lifting height (changeable range of the lifting height Hr) is used for determination can also be adopted. In this application example, when the height higher than Hc+Hr exists in the above-described changeable range in the determination by the determination unit 21d, it is possible to permit the picking up of the object to the truck T and execute the control for the picking up. On the other hand, in a case where such a height does not exist, the picking up is not permitted, and notification to the administrator or the like or stop of control in a case where control is being performed may be executed.

Furthermore, the processing of the dropped off scene and the picking up scene has been described with reference to FIGS. 8 and 9, but any processing may be configured to be automatically executed. For example, the remote control apparatus 20 can be configured to automatically perform the installation simply by designating the object to be conveyed and the position thereof, the forklift F used for conveyance, and the truck or shelf at the installation destination. For example, the remote control apparatus 20 may detect the position of the truck with the camera 30 or the like, and the forklift F may automatically pick up the object according to the information from the remote control apparatus 20 and load (dropping off) the object on the loading platform of the truck. In addition, by constructing a system including a truck allocation management system or a warehouse management system, designation as described above can also be automatically performed.

In addition, it is possible to configure such that picking up is automatically executed by adopting a similar information acquisition method in a picking up scene. In addition, a series of processing procedures such as dropping off after picking up can also be configured to be automatically executed in a similar manner.

Furthermore, as illustrated in steps S17 and S27, the motion determination system 100 can execute processing of stopping the dropping off or picking up of the forklift F in a case where the determination unit 21d determines that the motion is not executable. In addition, as illustrated in steps S18 and S28, the motion determination system 100 can also execute processing of notifying the management apparatus that manages the movement of the forklift F. This notification corresponds to an error notification. Of course, the motion determination system 100 may be configured to execute any one of the stop processing and the notification processing, may be configured to execute both of them, or may be configured not to execute any of them.

As described above, with reference to FIGS. 8 and 9, the processing example of determining whether the upper surface of the cargo Ca is not in contact with the ceiling Tu of the loading platform Tc or the upper surface Ru of the storage area of the shelf R has been described. The present example embodiment can also be configured to execute at least one of the following various application processing examples in addition to or instead of such a processing example.

The first application processing example is processing of determining whether the motion can be executed depending on whether the lower surface of the object (the bottom surface of the cargo loading pallet Cp in the example of FIG. 5) does not contact the bottom surface Td of the loading platform Tc or the bottom surface Rd of the storage area of the shelf R.

In the first application processing example, in the processing example of FIG. 8, the loadable height H1 may be acquired in step S11, and the following determination may be made in step S13. That is, the determination unit 21d may determine whether the loadable height H1 is higher than the sum of the height Hc of the object (the upper frame of the cargo Ca and the cargo loading pallet Cp) and the lifting height Hr. By this determination, it is possible to determine whether the bottom surface of the cargo loading pallet Cp is rubbed against the bottom surface Td of the loading platform Tc of the truck T. In this case, the present invention can be applied not only to the processing from the state in which the fork Fb is at the bottom of the movable range as a premise in the processing example of FIG. 8, but also to, for example, a case where the processing is started from a state in which the fork Fb is at the top of the movable range or a state in which the fork Fb is above the bottom surface Td of the loading platform Tc.

In the first application processing example, in the processing example of FIG. 9, similar determination can be performed in step S23. Note that, in the processing example of FIG. 9, since the example of controlling to the picking up possible position is exemplified, such determination is unnecessary, but it functions usefully in a case where the example of raising and lowering to the picking up possible position is not adopted. In this case, the present invention can be applied not only to the processing from the state in which the fork Fb is at the bottom of the movable range as a premise in the processing example of FIG. 9, but also to, for example, a case where the processing is started from a state in which the fork Fb is at the top of the movable range or a state in which the fork Fb is above the bottom surface Td of the loading platform Tc.

Not only the contact in the height direction but also the presence or absence of contact in the width direction and the depth direction can be determined, and will be described as a second application processing example and a third application processing example, respectively. However, for example, in a case where the truck T or the shelf R capable of dropping off or picking up an object so as not to contact in the width direction and the depth direction is prepared in advance, it is only necessary to determine the height direction.

The second application processing example is a processing of determining whether the motion can be executed depending on whether the width direction of the object is in contact with the wall of the side surface of the loading platform Tc or the wall of the side surface of the storage area of the shelf R. In this case, the determination unit 21d may determine whether the width of the loading platform Tc of the truck T or the width W1 of the storage area of the shelf R (see FIG. 7) is longer than the larger one of the width of the fork Fb and the width of the object (the larger one of the width of the cargo Cp and the width of the cargo loading pallet Cp). With this determination, it is possible to avoid that it does not enter the loading platform Tc of the truck T due to the influence of the width of the object and the width of the fork Fb.

The third application processing example is processing of determining whether the motion can be executed depending on whether the depth direction of the object does not contact the back wall of the loading platform Tc or the back wall of the storage area of the shelf R. In this case, the determination unit 21d may determine whether the depth D1 of the loading platform Tc of the truck T or the depth D1 (see FIG. 7) of the storage area of the shelf R is longer than the following value. The next value is the larger length of the depth (length) Dr of the fork Fb and the depth of the object (the larger of the depth of the cargo Cp and the depth of the cargo loading pallet Cp). The depth of the fork Fb can be changed depending on the expansion/contraction length of the expansion/contraction portion Fr, but since there is a limit to the expansion/contraction length, such determination is particularly advantageous. This determination can prevent the object from colliding with the back wall (the wall on the driver's seat side) of the truck T.

As described above, the determination unit 21d may determine whether dropping off or picking up is possible depending on whether all the conditions of the three pieces of information indicating the width including the height are satisfied. Of course, in a case where it is known that there is a sufficient margin, that is, in a case where the determination is made on the premise that there is a sufficient margin, it is not necessary to consider both the upper limit and the lower limit or all three pieces of information.

As described in the processing examples of FIGS. 8 and 9 and the first to third application processing examples, the determination unit 21d can execute determination as follows. That is, the determination unit 21d first specifies size information indicating a size necessary for enabling the forklift F to execute the dropping off or picking up with respect to the object based on the object information and the forklift information. Next, the determination unit 21d determines whether the dropping off or the picking up with respect to the object can be executed at the motion place according to the size information and the range information.

As described above, according to the present example embodiment, since the determination is performed using the forklift information as the information for determination, it is possible to perform the determination for safely dropping off or picking up the object with the forklift. That is, according to the present example embodiment, the object can be dropped off or picked up in consideration of safety, and as a result, the cargo can be efficiently conveyed. In addition, in the present example embodiment, even if the storage limit of the object such as the loading platform Tc and the ceiling of the shelf R cannot be visually confirmed, the height and the like that theoretically collide can be known, so that the forklift can be operated with a sense of security even at the time of remote control or manual operation.

In the present example embodiment, an example in which the mobile apparatus is a forklift has been mainly described, but the configuration and shape of the forklift are not limited to those exemplified, and a mobile apparatus other than the forklift can also be applied.

Examples of the mobile apparatus include a crane vehicle or a robot that hangs an object from a hole or the like provided in the object, a robot that holds a handle or the like provided in the object in the vertical direction and lifts or lowers the object with an arm, and a robot that can load the object on the arm or the like.

The loading unit in the case of the method of suspending the object corresponds to a hanging tool including a hook, a wire, and the like, and the sensor for detecting the load amount in this case can be installed in a winch portion of the hook or the wire. In this case, loading an object means that the object is hung and lifted by being hooked on a hanging tool under a part of the object, for example, a through hole, a bottomed hole, or a protrusion provided in the object. In the case of a robot that grips an object in the vertical direction, the loading unit corresponds to a member on the lower side of the grip portion. In this case, loading the object corresponds to placing the object on the lower member of the grip portion and sandwiching the object with the upper member of the grip portion. In the case of a robot capable of loading cargo and a cargo loading pallet on an arm or the like, similarly to the forklift, the loading unit corresponds to a portion for loading an object. In this case, loading the object means loading the object on the arm or the like similarly to the forklift.

The forklift F is an example of an apparatus including a loading unit for loading an object and lifting or lowering means (lifting or lowering portion) for lifting or lowering the loading unit. As described in the processing example of FIG. 8 and the processing example of FIG. 9, in a case where the mobile apparatus is such an apparatus, it can be said that it is beneficial that each piece of information includes at least information in the height direction. As exemplified by the height Hr, the information in the height direction in the apparatus information corresponds to information indicating the height of the loading unit with respect to the reference position in the mobile apparatus. The reference position refers to a reference vertical position (for example, the lowest portion of a tire, that is, the ground, or the like) set in a portion other than the loading unit. In addition, the information in the height direction in the object information corresponds to the information indicating the height of the object as exemplified by the height Hc, and the information in the height direction in the range information corresponds to the information indicating the range in the height direction as exemplified by the heights H1 and H2.

The forklift F is an example of an apparatus including horizontal moving means (horizontal moving unit) that moves the loading unit in a horizontal direction indicated by the expansion/contraction portion Fr. As described in the second application processing example and the third application processing example, in a case where the mobile apparatus is such an apparatus, it can be said that it is beneficial that each piece of information includes at least information in the horizontal direction. As exemplified by the depth Dr, the horizontal information in the apparatus information corresponds to information indicating the position of the loading unit in the horizontal direction with respect to the reference position in the mobile apparatus. The reference position refers to a reference horizontal position (for example, a position of a tire, a position of a driver's seat, and the like) set in a portion other than the loading unit. In addition, the information in the horizontal direction in the object information corresponds to information indicating at least one of the length of the depth and the length of the width of the object. In addition, the information in the horizontal direction in the range information corresponds to information indicating at least one of the length of the depth and the length of the width of the storage area of the loading platform or the shelf as exemplified by the depth D1, the width W1, and the like.

In addition, the mobile apparatus is not limited to the example including the loading unit, and examples thereof include a robot with an arm, a bucket fork, and the like that include a holding unit that holds and lifts the object from both sides even in a case where the object does not have a projection portion.

In addition, the type of the above mobile apparatus is not limited to a mobile apparatus that moves on the ground, and may be an object that moves under water or over water, such as a ship or an underwater drone, or an object (flight vehicle) that moves in the air, such as an aircraft or a flying drone. Furthermore, the mobile apparatus may be a mobile robot such as an automated guided vehicle (AGV).

In addition, it does not matter whether the mobile apparatus has a function of moving by autonomous control, a function of moving by a remote operation or a driving operation by an operator (driver), or a semi-autonomous function having both functions. However, in particular, in a case where the driver can board or cannot board, and the driver does not board with a remote operation function, an autonomous operation function, or the like, there is a possibility that the confirmation is insufficient and the cargo is damaged. However, in the present example embodiment, the possibility of damage of the cargo can be reduced even in such a case.

In a case in which the mobile apparatus has a function of moving according to autonomous control, the mobile apparatus performs automatic driving (autonomous driving) based on information of various sensors mounted on the mobile apparatus. Further, the mobile apparatus may be configured to be able to switch between, for example, automatic driving and manual driving by an occupant (for example, a driver in a vehicle in the case of an automatic driving vehicle). Note that the mobile apparatus can also be referred to as a mobile body.

### Second Example Embodiment

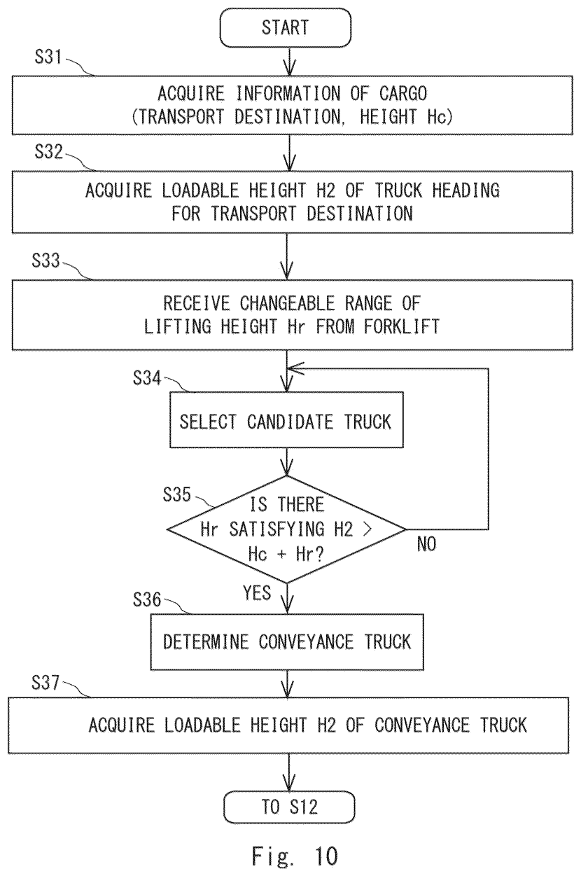

A second example embodiment will be described with reference to FIG. 10, focusing on differences from the first example embodiment, but various examples described in the first example embodiment can be applied in the present example embodiment. In addition, since the function of the motion determination system according to the present example embodiment is the same as the function of the motion determination system 100 of FIG. 4 except for a part thereof, the present example embodiment will also be described based on the configuration example of FIG. 4 and the notation of the height and the like of FIGS. 6 and 7.

The range information acquisition unit 21c in the present example embodiment acquires range information at the motion place specified according to the object information. The present example embodiment is different from the first example embodiment in this point. In the present example embodiment, the motion place is not determined in advance, and can be specified according to the object information.

An example in which the procedure of the scene A, that is, the procedure of loading the object from the fork Fb onto the loading platform of a certain truck is applied to the present example embodiment will be described with reference to FIG. 10. FIG. 10 is a flowchart for illustrating an example of a procedure of specifying the truck T of FIG. 6 as a loading destination of the object and loading the object from the fork Fb of FIG. 6 onto the loading platform Tc of the truck T in the motion determination system 100 according to the present example embodiment.

In the scene A according to the present example embodiment, first, an operation of an installation instruction of the object on the truck by the forklift F is received from the operation input unit 24 of the remote control apparatus 20. When the operation of the installation instruction is received, the object information acquisition unit 21a acquires, as object information, information regarding the cargo Ca including the transport destination that is the destination to which the object is to be finally delivered and the height Hc (step S31). The object information including the information indicating the transport destination can be acquired from, for example, a storage device inside the remote control apparatus 20, an external cargo management system connected to the remote control apparatus 20 via the communication unit 22.

Next, the range information acquisition unit 21c acquires the loadable height H2 for the truck heading for the transport destination, specifically, all the trucks that are not currently conveying the cargo and are heading for the direction of the transport destination from now on, based on the object information (step S32).

Next, the apparatus information acquisition unit 21b requests the forklift F to provide the changeable range of the lifting height Hr (that is, the movable range in the height direction of the fork Fb) as the information indicating the lifting height Hr of the fork Fb, and receives the information indicating the changeable range from the forklift F (step S33). Note that steps S31 and S32 can be executed after step S33, or they can be executed simultaneously in parallel.

After the processing of steps S31 to S33, the range information acquisition unit 21c sequentially selects candidate trucks from the truck group of which the loadable height H2 has been acquired in step S32 (step S34). Then, the range information acquisition unit 21c determines whether Hr satisfying H2>Hc+Hr exists in the changeable range for the selected candidate truck and the forklift F (step S35).

If NO in step S35, the processing returns to step S34 to select the next candidate truck. Regardless of the order of selection in step S34, the order may be the order of the truck identification information, or the order determined based on the remaining fuel information or the information indicating the operating time of the truck as long as the information is managed.

If YES in step S35, the range information acquisition unit 21c determines the truck T to be conveyed (step S36). In step S36, the motion place which is the dropping off place is determined as the loading platform Tc of the truck T. Next, the range information acquisition unit 21c acquires the loadable height H2 of the conveyance truck, that is, the loading platform Tc of the truck T (step S37). The loadable height H2 acquired in step S37 has already been acquired in step S32, and the loadable height H2 may be temporarily stored in the work memory at the time of step S32.

Next, the processing of steps S12 to S18 in the processing example of FIG. 8 is executed for the truck T determined in step S36.

As described above, in the processing example of FIG. 10 and the processing example following the processing example of FIG. 8, a scene in which the object is dropped off to the loading platform Tc of the truck T has been described. However, the present invention can be similarly applied to a scene in which the object is dropped off to the shelf R as illustrated in FIG. 7. For example, the same application is possible as long as each storage area of the shelf R and the transport destination are associated in advance. This example is particularly advantageous in a case where the shelf R has one storage area and is loaded onto a large truck for each shelf R.

### Third Example Embodiment

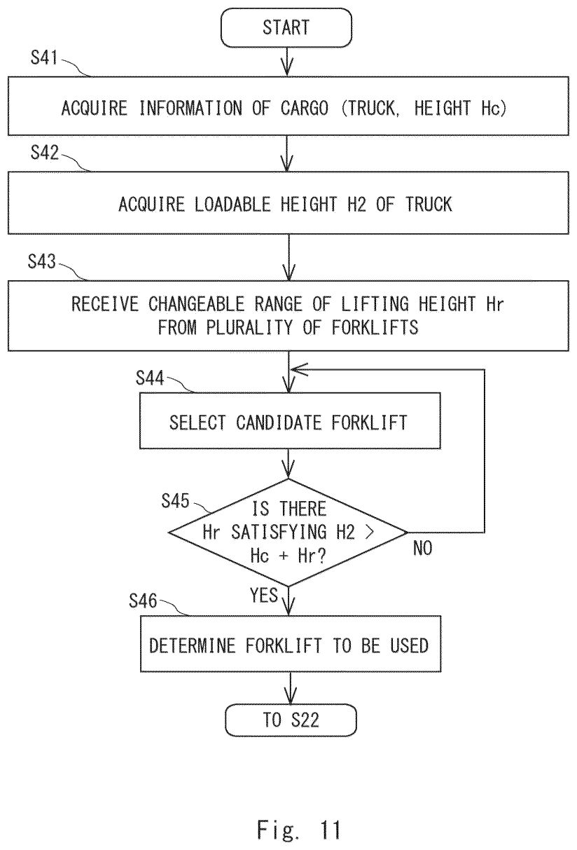

A third example embodiment will be described with reference to FIG. 11, focusing on differences from the second example embodiment, but various examples described in the first and second example embodiments can be applied in the present example embodiment. In addition, since the function of the motion determination system according to the present example embodiment is the same as the function of the motion determination system 100 of FIG. 4 except for a part thereof, the present example embodiment will also be described based on the configuration example of FIG. 4 and the notation of the height and the like of FIGS. 6 and 7.

In the processing example of FIG. 10, the processing example of FIG. 8, and the subsequent processing example in the second example embodiment, a scene in which the object is dropped off to the loading platform Tc of the truck T is described. On the other hand, in the present example embodiment, processing for a scene for picking up an object from the loading platform Tc of the truck T (scene B) will be described. Also in the scene B, if the object to be selected is a forklift instead of a truck, the same concept as that of the second example embodiment can be applied.

The apparatus information acquisition unit 21b according to the present example embodiment specifies the forklift F according to the object information, and acquires the forklift information that is the apparatus information of the specified forklift F. The present example embodiment is different from the first or second example embodiment in this point. In the present example embodiment, the forklift F to be used is not determined in advance, and can be specified according to the object information.

An example in which the procedure of the scene B, that is, the procedure of picking up an object with a fork of a certain forklift from the loading platform Tc of the truck T is applied to the present example embodiment will be described with reference to FIG. 11. FIG. 11 is a flowchart for illustrating an example of a procedure of specifying a forklift for picking up an object from the loading platform Tc of the truck T and picking up the object with a fork of the forklift in the motion determination system 100 according to the present example embodiment.

In the scene B in the present example embodiment, first, an operation of an instruction for picking up an object loaded on the loading platform Tc of the truck T by an arbitrary forklift is received from the operation input unit 24 of the remote control apparatus 20. In response to this operation, the object information acquisition unit 21a acquires information of the cargo Ca including the loaded truck T and the height Hc as the object information (step S41). The object information including the information indicating the loaded truck T can be acquired from, for example, a storage device inside the remote control apparatus 20, an external cargo management system connected to the remote control apparatus 20 via the communication unit 22.

Next, the range information acquisition unit 21c acquires the loadable height H2 of the truck T on which the object is loaded based on the object information (step S42).

Next, the apparatus information acquisition unit 21b requests the changeable range of the lifting height Hr (that is, the movable range in the height direction of the fork) as the information indicating the lifting height Hr of the fork from the plurality of forklifts, and receives the information indicating the changeable range from each forklift (step S43). Note that steps S41 and S42 can be executed after step S43, or they can be executed simultaneously in parallel.

After the processing of steps S31 to S33, the apparatus information acquisition unit 21b sequentially selects a candidate forklift from the forklift group of which the changeable range is acquired in step S43 (step S44). The apparatus information acquisition unit 21b then determines whether Hr satisfying H2>Hc+Hr is present in the changeable range for the selected candidate forklift and the truck T (step S45).

If NO in step S45, the processing returns to step S44 to select the next candidate forklift. The order of selection in step S44 is not limited, and the order may be the order of the forklift identification information or the order determined based on the remaining fuel information and the operating time information of the forklift if the information is managed.

If YES in step S45, the apparatus information acquisition unit 21b determines the forklift F to be used for picking up (step S46). Next, the processing of steps S22 to S28 in the processing example of FIG. 9 is executed for the forklift F determined in step S46.

As described above, in the processing example of FIG. 10 and the processing example following the processing example of FIG. 8, a scene in which the object is picked up from the loading platform Tc of the truck T has been described. However, the present invention can be similarly applied to a scene in which the object is picked up from the shelf R as illustrated in FIG. 7.

### Fourth Example Embodiment

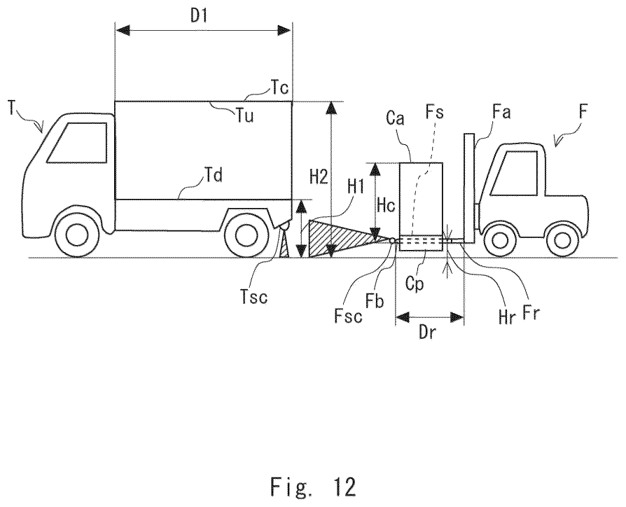

A fourth example embodiment will be described with reference to FIG. 12, focusing on differences from the first example embodiment, but various examples described in the first to third example embodiments can be applied in the present example embodiment. FIG. 12 is a side view schematically illustrating an example of a loading platform of a truck, which is an example of a motion place used for motion determination in the motion determination system according to the present example embodiment, together with an example of a forklift.

In the first example embodiment, in the processing example of FIG. 8 and the processing example of FIG. 9, whether the motion can be executed is determined based on whether the upper surface of the object (the upper surface of the cargo Ca in the example of FIG. 5) does not contact the ceiling Tu of the loading platform Tc. That is, in the first example embodiment, it is determined whether it collides with the inner wall portion of the loading platform Tc or the housing of the shelf R constituting the motion place.

On the other hand, in the present example embodiment, whether the motion can be executed is determined based on whether the upper surface of the object does not contact the outer surface of the loading platform Tc, that is, whether the object collides with the outer wall portion. Hereinafter, as the outer surface, only the lower surface, that is, the bottom surface at a position facing the ground will be described, but other outer surfaces can be similarly applied.

In the present example embodiment, in the motion determination system 100 of FIG. 4, as illustrated in FIG. 12, a distance sensor Fsc is provided in the forklift F, or a distance sensor Tsc is provided on the rear side surface of the truck T. The distance measurement method in the distance sensor Fsc or the distance sensor Tsc is not limited as long as the distance sensor Fsc or the distance sensor Tsc is disposed at a position where the height of the bottom surface of the loading platform Tc behind the truck T at a position facing the ground can be measured as a measurement target.

First, an application example to the processing example of FIG. 8 will be described. In a case where the present example embodiment is applied to the processing example of FIG. 8, in step S13, the determination unit 21d may determine whether not only the condition of H2>Hc+Hr but also the condition that Hc+Hr is longer than the distance measured by the distance sensor Fsc or the distance sensor Tsc is satisfied. The processing may proceed to step S14 in a case where both conditions are satisfied, and the processing may proceed to step S15 in other cases. By determining the latter condition, it is possible to determine whether the upper surface of the cargo Ca and the bottom surface behind the truck T (a surface disposed at a position schematically indicated by the distance sensor Tsc in FIG. 12) do not collide with each other. In particular, it is advantageous in a case where the processing from the state in which the fork Fb assumed in the processing example of FIG. 8 is at the bottom of the movable range is performed.

In addition, it is also possible to provide a distance sensor arranged to be able to measure the height of the upper outer surface of the loading platform Tc. Then, in step S13, the determination unit 21d may determine whether not only the condition of H2>Hc+Hr but also the condition that the value obtained by subtracting the thickness of the fork Fb from Hr is longer than the distance measured by the distance sensor Fsc or the distance sensor Tsc is satisfied. The processing may proceed to step S14 in a case where both conditions are satisfied, and the processing may proceed to step S15 in other cases. By determining the latter condition, it is possible to determine whether the lower surface of the fork Fb and the upper outer surface behind the truck T do not collide with each other. In particular, for example, the present invention can be advantageously applied to a case where the processing is started from a state where the fork Fb is above the upper outer surface of the loading platform Tc.

Next, an application example to the processing example of FIG. 9 will be described. In a case where the present example embodiment is applied to the processing example of FIG. 9, in step S23, it may be determined whether not only the condition of H2>Hc+Hr but also the condition that Hr is longer than the distance measured by the distance sensor Fsc or the distance sensor Tsc is satisfied. The processing may proceed to step S24 in a case where both conditions are satisfied, and the processing may proceed to step S27 in other cases. By determining the latter condition, it is possible to determine whether or not the upper surface of the fork Fb and the bottom surface on the rear side of the truck T do not collide with each other. In particular, it is advantageous in a case where the processing from the state in which the fork Fb assumed in the processing example of FIG. 9 is at the bottom of the movable range is performed.

In addition, it is also possible to provide a distance sensor arranged to be able to measure the height of the upper outer surface of the loading platform Tc. Then, in step S23, the determination unit 21d may determine whether not only the condition of H2>Hc+Hr but also the condition that the value obtained by subtracting the thickness of the fork Fb from Hr is longer than the distance measured by the distance sensor Fsc or the distance sensor Tsc is satisfied. The processing may proceed to step S24 in a case where both conditions are satisfied, and the processing may proceed to step S27 in other cases. By determining the latter condition, it is possible to determine whether the lower surface of the fork Fb and the upper outer surface behind the truck T do not collide with each other. In particular, for example, the present invention can be advantageously applied to a case where the processing is started from a state where the fork Fb is above the upper outer surface of the loading platform Tc.

### Fifth Example Embodiment

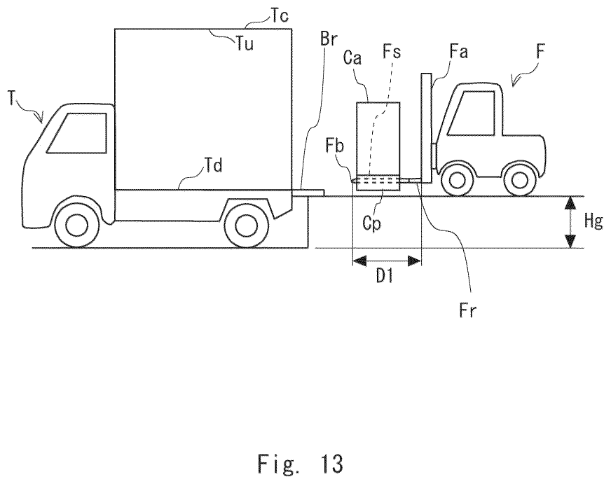

A fifth example embodiment will be described with reference to FIG. 13, focusing on differences from the first example embodiment, but various examples described in the first to fourth example embodiments can be applied in the present example embodiment. FIG. 13 is a side view schematically illustrating an example of a loading platform of a truck, which is an example of a motion place used for motion determination in the motion determination system according to the present example embodiment, together with an example of a forklift.

In the present example embodiment, in the motion determination system 100 of FIG. 4, as illustrated in FIG. 13, the moving road surface of the forklift F is made higher than the moving road surface of the truck T by the height Hg. Therefore, the condition regarding the height direction described in the first example embodiment is obtained by adding the height Hg. Although the detailed description thereof is omitted, the determination unit 21d may perform the determination basically using a value converted to the height from the same reference plane in the loading platform Tc and the forklift F. In the present example embodiment, it is not necessary to consider the collision between the bottom surface on the rear side of the truck T and the upper surface of the cargo Ca or the fork Fb described in the fourth example embodiment.

In addition, as illustrated in FIG. 13, in a case where the forklift F is small enough to be placed on the loading platform Tc, it is preferable to use a bridge portion Br separately prepared or provided on the loading platform Tc or the like so that the forklift F can move on the bridge portion Br. Although the example in which the bridge portion Br is arranged horizontally has been described, the bridge portion Br can be arranged obliquely, and even if the height Hg is zero, the long bridge portion Br can be arranged obliquely. In addition, the present example embodiment can be similarly used not only for the loading platform Tc but also for the storage area of the shelf R.

### Sixth Example Embodiment

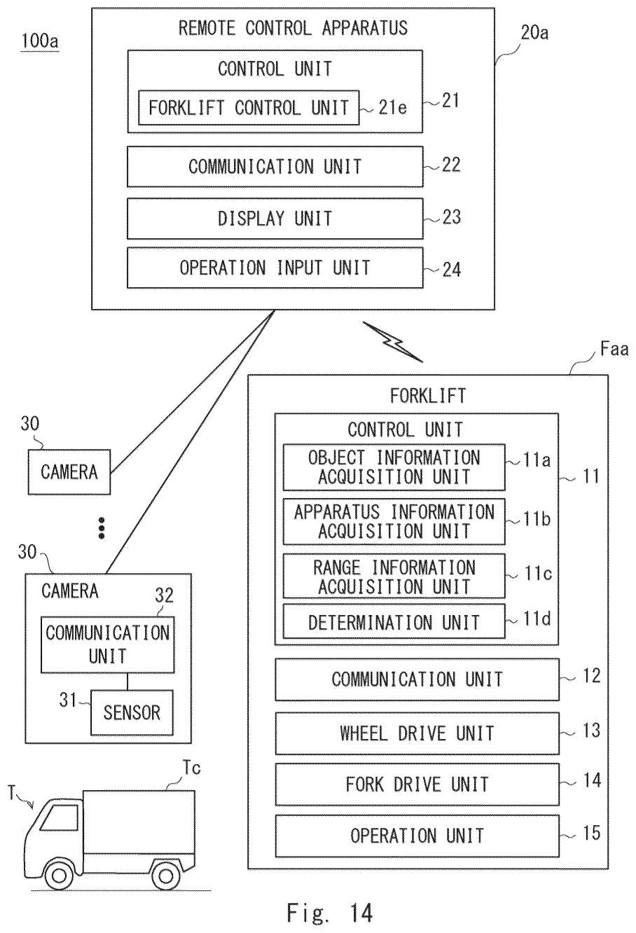

A sixth example embodiment will be described with reference to FIG. 14, focusing on differences from the first example embodiment, but various examples described in the first to fifth example embodiments can be applied in the present example embodiment. FIG. 14 is a block diagram illustrating a detailed configuration example of a motion determination system according to the present example embodiment.

As illustrated in FIG. 14, a motion determination system 100a according to the present example embodiment is a system in which a distributed form of functions is different from that of the motion determination system 100 illustrated in FIG. 4. The motion determination system 100a includes one or a plurality of cameras 30, a remote control apparatus 20a, and one or a plurality of forklifts Faa.

The remote control apparatus 20a includes the control unit 21, the communication unit 22, the display unit 23, and the operation input unit 24. The control unit 21 is obtained by removing the object information acquisition unit 21a, the apparatus information acquisition unit 21b, the range information acquisition unit 21c, and the determination unit 21d from the remote control apparatus 20 of FIG. 4. Instead, the forklift Faa is configured such that the control unit 11 of the forklift F in FIG. 4 includes an object information acquisition unit 11a, an apparatus information acquisition unit 11b, a range information acquisition unit 11c, and a determination unit 11d. The control unit 21 can control the communication unit 22, the display unit 23, and the operation input unit 24, and achieves the function of the remote control apparatus 20a by linking the respective components as necessary.

The object information acquisition unit 11a can acquire the object information from the remote control apparatus 20a or from the outside via the remote control apparatus 20a. The apparatus information acquisition unit 11b can acquire the forklift information managed by the forklift Faa, or can acquire the forklift information of the forklift Faa from the remote control apparatus 20a or from the outside via the remote control apparatus 20a. The range information acquisition unit 11c can acquire the range information from the remote control apparatus 20a or from the outside via the remote control apparatus 20a. The determination unit 11d determines whether dropping off or picking up with respect to the object can be executed at the motion place according to the acquired object information, forklift information, and range information.

In addition, the description of FIG. 4 and the like of the first example embodiment can be cited for details of each component of the motion determination system 100a, and basically, only a path for exchanging information is different.

As described above, in the present example embodiment, in addition to the effects of the first example embodiment, a necessary function can be realized mainly by the forklift Faa alone. However, as described in the first example embodiment, the configuration of FIG. 4 and the configuration of FIG. 14 are not limited regardless of the form of function distribution. Further, as described above, all the components including the camera 30 can be mounted on the forklift. In addition, the functions that can be provided on the remote control apparatus side can also be provided in a cloud server or the like.

### Seventh Example Embodiment

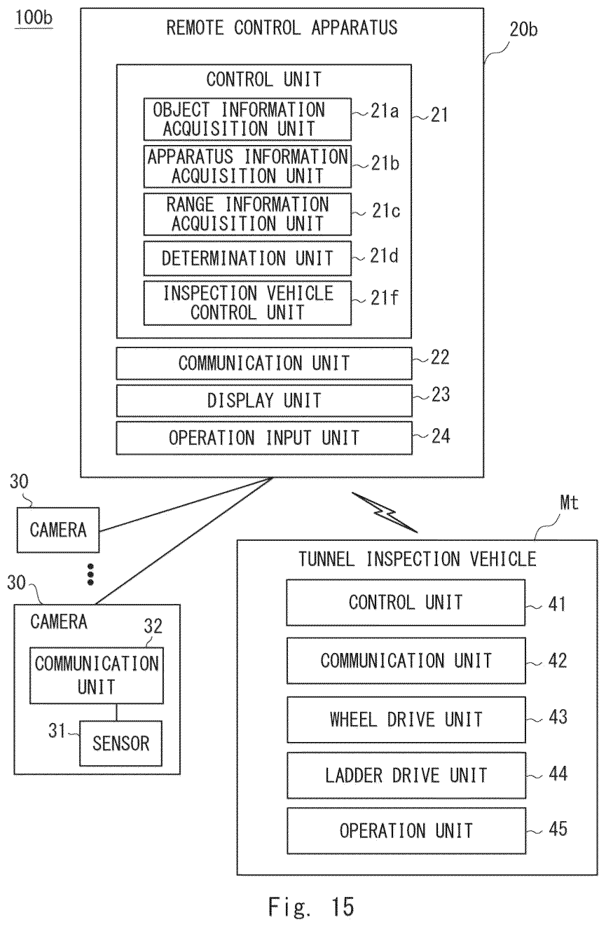

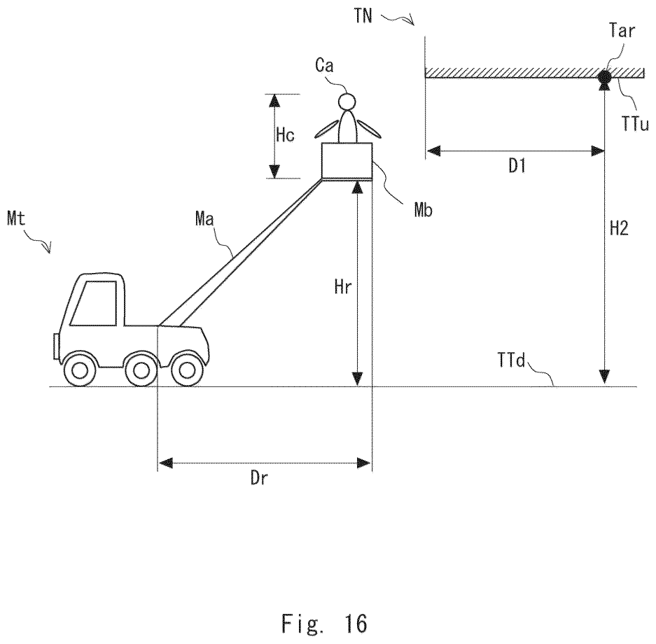

A seventh example embodiment will be described with reference to FIG. 15, focusing on differences from the first example embodiment, but various examples described in the first to sixth example embodiments can be applied in the present example embodiment. FIG. 15 is a block diagram illustrating a detailed configuration example of a motion determination system according to the present example embodiment. FIG. 16 is a side view schematically illustrating an example of a tunnel, which is an example of a motion place used for motion determination in a motion determination system 100b of FIG. 15, together with an example of a tunnel inspection vehicle.

As illustrated in FIG. 15, the motion determination system 100b according to the present example embodiment includes one or a plurality of cameras 30, the remote control apparatus 20b, and one or a plurality of tunnel inspection vehicles Mt. The motion determination system 100b includes the remote control apparatus 20b, the tunnel inspection vehicle Mt, and an inspection vehicle control unit 21f in place of the remote control apparatus 20, the forklift F, and the forklift control unit 21e in the motion determination system 100 illustrated in FIG. 4, respectively. The camera 30 can be disposed in the tunnel TN, but can also be disposed in another vehicle. Regardless of the arrangement of the remote control apparatus 20b, for example, the remote control apparatus can be provided in another vehicle.

The remote control apparatus 20b can include the inspection vehicle control unit 21f that remotely controls the tunnel inspection vehicle Mt in the control unit 21. In addition, the remote control apparatus 20b includes, in the control unit 21, the object information acquisition unit 21a, the apparatus information acquisition unit 21b, the range information acquisition unit 21c, and the determination unit 21d. Each unit differs slightly from the parts and functions of the same names in the remote control apparatus 20 in FIG. 4, and has a function as described below in the present example embodiment. However, in the following description, differences from the remote control apparatus 20 of FIG. 4 will be mainly described, and description of similar portions will be omitted.

The object information acquisition unit 21a acquires object information including information regarding the size of an object that is a person or a robot. Here, the robot may be an autonomous control robot or a remote control robot. The size of the object may include at least one of a height, a width, and a depth. The apparatus information acquisition unit 21b acquires apparatus information that is information regarding a mobile apparatus that loads and moves an object on a loading unit. In the configuration example of FIG. 15, the tunnel inspection vehicle Mt is an example of the mobile apparatus, and a working deck Mb is an example of the loading unit.

The range information acquisition unit 21c acquires range information indicating a range in which the object can be moved, that is, condition information indicating a condition for moving the object at the motion place where the object is moved by the mobile apparatus. In the configuration examples of FIGS. 15 and 16, the inspection target point (target point) Tar of the tunnel TN is an example of the motion place.

The determination unit 21d determines whether the object can be performed the motion at the motion place according to the object information, the apparatus information, and the range information. In this example, the above operation can refer to a motion, work, and the like for tunnel inspection.

The tunnel inspection vehicle Mt includes a control unit 41, a communication unit 42, a wheel drive unit 43, a ladder drive unit 44, and an operation unit 45, which correspond to the control unit 11, the communication unit 12, the wheel drive unit 13, the fork drive unit 14, and the operation unit 15 in FIG. 4, respectively. The control unit 41 can control the communication unit 42, the wheel drive unit 43, the ladder drive unit 44, and the operation unit 45, and cooperates the respective parts as necessary to implement the function of the tunnel inspection vehicle Mt. Therefore, a detailed description of the function of each unit of the tunnel inspection vehicle Mt will be omitted except for the description of the ladder drive unit 44.

As illustrated in FIG. 16, the tunnel inspection vehicle Mt is provided with a ladder Ma, and the working deck Mb is installed at the tip of the ladder Ma. The ladder drive unit 44 drives the ladder Ma to expand or contract, change a direction, or the like. This driving is controlled by the inspection vehicle control unit 21f via the control unit 41. The shape and structure of the working deck Mb, the structure of the ladder Ma, the expansion/contraction mechanism, and the like are not limited.

In the example of FIG. 16, the motion place is a tunnel TN, which is an example of a location where a wall exists on the upper surface side, and the range information may include at least information indicating the height of the wall. Further, the object information may include at least information indicating the height of the object, and the apparatus information may include information indicating the height of the working deck Mb with respect to the reference position in the tunnel inspection vehicle Mt. The reference position refers to a reference vertical position (for example, the lowest portion of a tire, that is, the ground, or the like) set to a position other than the working deck Mb.

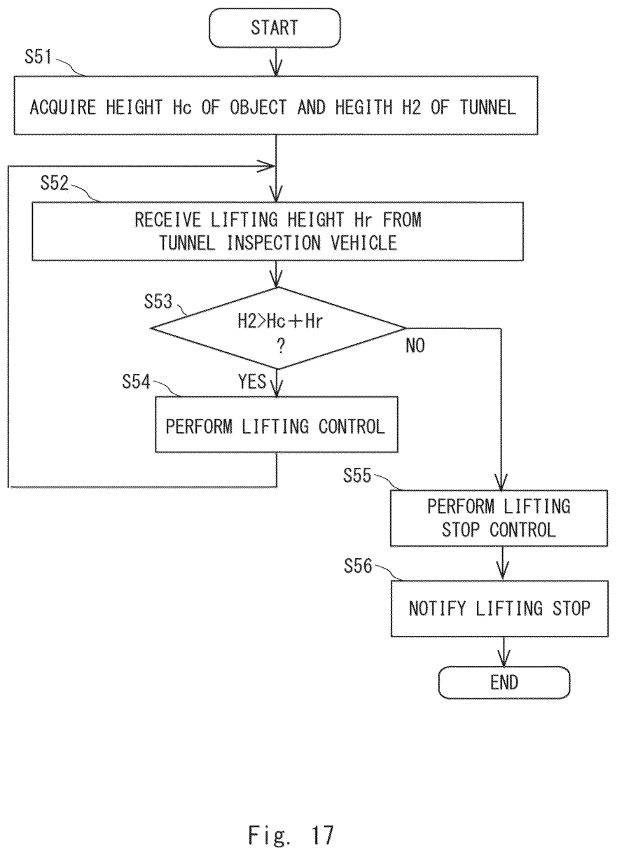

Next, a procedure for carrying the object Ca, which is a person or a robot, from the state of being placed on the working deck Mb to the target position Tar of the tunnel TN, which is the motion place, by the tunnel inspection vehicle Mt will be described with reference to FIG. 17. FIG. 17 is a flowchart for illustrating an example of a procedure for carrying the object Ca to a motion place by the tunnel inspection vehicle Mt in the motion determination system 100b of FIG. 15. Note that, for simplification of description, description of transmission and reception of information via the communication unit 42, the communication unit 22, and the communication unit 32 will be omitted below. In order to simplify the description, the processing from the state in which the working deck Mb is located at the lowest position in the movable range will be described below, but the present invention is not limited thereto.

In addition, in order to simplify the description, a procedure from a state in which the working deck Mb of the tunnel inspection vehicle Mt is moved to the lower side of the inspection target point Tar inside the tunnel TN using the remote control apparatus 20b will be described. In the present example embodiment, a method of controlling the movement of the working deck Mb to the lower side of the inspection target point Tar is not limited. For example, while confirming an image obtained by the camera 30, a camera (not illustrated) mounted on the tunnel inspection vehicle Mt, and the like, the operator can execute control of the movement of the tunnel inspection vehicle Mt and the expansion and contraction of the ladder Ma by sequential remote operation from the operation input unit 24. Note that the tunnel inspection vehicle Mt can be automatically moved to the vicinity of the inspection target point Tar of the tunnel TN by providing the function of acquiring the position information.

First, in a case where an operation of an instruction to carry the object Ca to the inspection target point Tar of the tunnel TN by the tunnel inspection vehicle Mt is received from the operation input unit 24 of the remote control apparatus 20b, the object information acquisition unit 21a and the range information acquisition unit 21c acquire information. That is, the object information acquisition unit 21a and the range information acquisition unit 21c acquire information indicating the height Hc of the object Ca and information indicating the height H2 of the inspection target point Tar of the tunnel TN, respectively (step S51). Here, the height Hc is set to be larger than the actual height by a predetermined length. Note that the inspection target point Tar is not limited to the point of the zenith portion TTu of the tunnel TN, and the height H2 may be different depending on the inspection target point Tar even at the same distance from the entrance or the exit of the tunnel TN.

Next, the apparatus information acquisition unit 21b requests the information indicating the lifting height Hr of the ladder Ma from the tunnel inspection vehicle Mt, and acquires the information indicating the lifting height Hr of the ladder Ma from the tunnel inspection vehicle Mt (step S52). Note that the order of steps S51 and S52 is irrelevant as long as the information has been acquired at the stage of step S53 described later, such as executing step S11 after step S12.

Next, the determination unit 21d determines whether the height H2 of the inspection target point Tar of the tunnel TN is higher than the sum of the height Hc of the object Ca and the lifting height Hr (step S53). By this determination, it can be determined whether the head (upper surface) of the object Ca is rubbed against the inspection target point Tar of the tunnel TN. Note that, in a case where step S54 to be described later has never been performed, the lifting height Hr of the ladder Ma acquired in a state where the ladder Ma is at the bottom of the movable range is used for the determination.

If YES in step S53, the inspection vehicle control unit 21f performs lifting control to lift the ladder Ma of the tunnel inspection vehicle Mt (step S54), and returns to step S52. In the tunnel inspection vehicle Mt subjected to the lifting control, the control unit 41 drives the ladder drive unit 44 to control the lifting of the ladder Ma, and the ladder Ma is lifted. Although the processing from the state in which the ladder Ma is at the bottom of the movable range has been described, the height of the ladder Ma in the case of carrying the object in the tunnel TN is not limited as long as it is within the tunnel TN.

In step S53 after step S54, the determination is made using the height after the lifting of the ladder Ma is controlled as the lifting height Hr of the ladder Ma.

On the other hand, if NO in step S53, it means that the object Ca has reached the inspection target point Tar which is the motion place, and thus, the inspection vehicle control unit 21f executes control to stop lifting (step S55). Next, the control unit 21 notifies the administrator or the like of the lifting stop (step S56), and ends the processing. The administrator or the like can receive the notification by, for example, the terminal apparatus inside the tunnel inspection vehicle Mt, inside another vehicle, inside the tunnel TN, or the like. Note that the order of steps S55 and S56 is not limited.

In addition, the first to third application processing examples described in the first example embodiment can also be similarly applied to the present example embodiment. For example, the depth D1 corresponds to the length illustrated in FIG. 16, and the width corresponds to the length in the direction perpendicular to the plane of drawing of FIG. 16 in the tunnel TN. However, similarly to the height H2, the width may be different depending on the height H2 of the inspection target point Tar even at the same distance from the entrance or the exit of the tunnel TN.

The apparatus information, the range information, the type of the object information, the acquisition method, and the like in the present example embodiment are basically similar to those in the first example embodiment. Furthermore, the functional distribution method illustrated in FIG. 14 can be similarly applied to the present example embodiment.

As described above, according to the present example embodiment, a person or a robot can be safely carried to an inspection point by the tunnel inspection vehicle.

In the present example embodiment, an example in which the mobile apparatus is a tunnel inspection vehicle has been described, but the mobile apparatus is not limited to the tunnel inspection vehicle. The present example embodiment can be applied to various types of mobile apparatuses such as a fire engine used in a scene where an object is not dropped off or picked up. However, even in a tunnel inspection vehicle, a fire engine, or the like, it is possible to drop off or pick up an object at the motion place. In the case of a tunnel inspection vehicle, for example, a room provided in a tunnel can be set as a motion place, and in the case of a fire engine, for example, a room at a fire site can be set as a motion place. That is, it can be said that examples of the mobile apparatuses in the first to sixth example embodiments include a tunnel inspection vehicle and a fire engine.

### Others

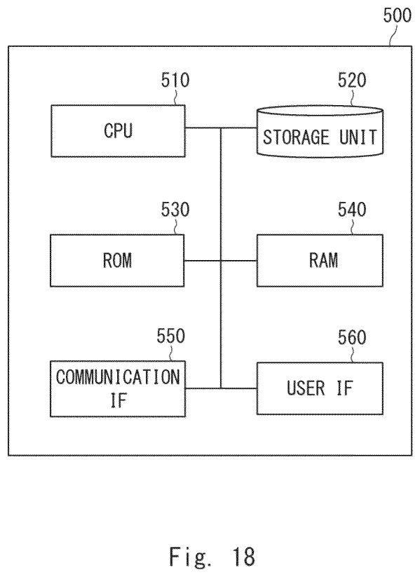

In the present disclosure, the motion determination apparatus, the remote control apparatus, the control unit of the forklift, the camera, and the like may include apparatuses such as a computer. FIG. 18 is a block diagram illustrating a configuration example of an apparatus. As illustrated in FIG. 18, an apparatus 500 includes a central processing unit (CPU) 510, a storage unit 520, a read only memory (ROM) 530, and a random access memory (RAM) 540 as a control unit. Further, the apparatus 500 may include a communication interface (IF) 550 and a user interface 560.

The apparatus 500 can be used as any of the motion determination apparatus, a remote control apparatus, a control unit of a forklift, and a camera. For example, the apparatus 500 can also be used as a control apparatus inside a forklift.

The communication interface 550 is an interface for connecting the apparatus 500 to a communication network through wired communication means, wireless communication means, or the like. The user interface 560 may include, for example, a display unit such as a display. Further, the user interface 560 may include input units such as a keyboard, a mouse, and a touch panel.

The storage unit 520 is an auxiliary storage device that can hold various types of data. The storage unit 520 need not to be necessarily part of the apparatus 500 and may be an external storage device or a cloud storage connected to the apparatus 500 via a network.

The ROM 530 is a non-volatile storage device. For example, a semiconductor storage device such as a flash memory having a relatively small capacity may be used for the ROM 530. A program that is executed by the CPU 510 may be stored in the storage unit 520 or the ROM 530. The storage unit 520 or the ROM 530 stores various programs for implementing the functions of the respective units in the apparatus 500.

The program includes a group of commands (or software codes) for causing a computer to perform one or more functions that have been described in the example embodiments when the program is read by the computer. The program may be stored in a non-transitory computer-readable medium or a tangible storage medium. As an example and not by way of limitation, a computer-readable medium or tangible storage medium includes a random-access memory (RAM), a read-only memory (ROM), a flash memory, a solid-state drive (SSD) or other memory technology, a compact disc (CD), a digital versatile disc (DVD), a Blu-ray (registered trademark) disk or other optical disk storage, a magnetic cassette, a magnetic tape, a magnetic disk storage, or other magnetic storage devices. The program may be transmitted on a transitory computer-readable medium or a communication medium. As an example and not by way of limitation, the transitory computer readable medium or the communication medium includes propagated signals in electrical, optical, acoustic, or any other form.

The RAM 540 is a volatile storage device. As the RAM 540, various types of semiconductor memory devices such as a dynamic random access memory (DRAM) or a static random access memory (SRAM) may be used. The RAM 540 may be used as an internal buffer for temporarily storing data or the like. The CPU 510 develops a program, stored in the storage unit 520 or the ROM 530, in the RAM 540, and executes the developed program. The function of each unit in the apparatus 500 can be realized by the CPU 510 executing the programs. The CPU 510 may include an internal buffer in which data or the like can be temporarily stored.

Although example embodiment has been described above in detail, the present disclosure is not limited to the above-described example embodiments, and the present disclosure also includes those that are obtained by making changes or modifications to the above-described example embodiments without departing from the spirit of the present disclosure.

For example, some or all of the above-described example embodiments may be described as the following supplementary notes, but the present disclosure is not limited to the following supplementary notes.

### (Supplementary Note 1)

A motion determination method including
acquiring object information including information regarding a size of an object,
acquiring apparatus information that is information regarding a mobile apparatus that moves the object,
acquiring range information indicating a range in which an object can be moved at a motion place where a motion of transferring the object by a mobile apparatus is executed, and
determining whether the motion of transferring the object is able to be executed on the object at the motion place according to the object information, the apparatus information, and the range information.

### (Supplementary Note 2)

The motion determination method according to supplementary note 1, in which
the determining includes
specifying size information indicating a size necessary for enabling the mobile apparatus to execute the motion of transferring the object on the object based on the object information and the apparatus information, and
determining whether the motion of transferring the object is able to be executed on the object at the motion place according to the size information and the range information.

### (Supplementary Note 3)

The motion determination method according to supplementary note 1 or 2, in which the acquiring the range information includes acquiring the range information at the motion place specified according to the object information.

### (Supplementary Note 4)

The motion determination method according to any one of supplementary notes 1 to 3, in which
the mobile apparatus includes loading means for loading the object, and
the apparatus information includes information indicating a size of the loading means.

### (Supplementary Note 5)

The motion determination method according to any one of supplementary notes 1 to 4, further including in a case where it is determined that the motion of transferring the object is not able to be executed on the object, executing at least one of processing of stopping the motion of transferring the object by the mobile apparatus and processing of notifying a management apparatus that manages movement of the mobile apparatus.

### (Supplementary Note 6)

The motion determination method according to any one of supplementary notes 1 to 5, in which
the mobile apparatus includes loading means for loading the object, and lifting or lowering means for lifting or lowering the loading means,
the apparatus information includes information indicating a height of the loading means with respect to a reference position in the mobile apparatus,
the object information includes at least information indicating a height of the object, and
the range information includes at least information indicating a range in a height direction.

### (Supplementary Note 7)

The motion determination method according to supplementary note 6, in which
the mobile apparatus includes horizontal moving means for moving the loading means in a horizontal direction,
the apparatus information includes information indicating a position of the loading means in a horizontal direction with respect to a reference position in the mobile apparatus,
the object information includes at least information indicating a length of the object in a horizontal direction, and
the range information includes at least information indicating a range in a horizontal direction.

### (Supplementary Note 8)

A motion determination system including
object information acquisition means for acquiring object information including information regarding a size of an object,
apparatus information acquisition means for acquiring apparatus information that is information regarding a mobile apparatus that moves the object,
range information acquisition means for acquiring range information indicating a range in which an object can be moved at a motion place where a motion of transferring the object by a mobile apparatus is executed, and
determination means for determining the motion of transferring the object is able to be executed on the object at the motion place according to the object information, the apparatus information, and the range information.

### (Supplementary Note 9)

The motion determination system according to supplementary note 8, in which
the determination means
specifies size information indicating a size necessary for enabling the mobile apparatus to execute the motion of transferring the object on the object based on the object information and the apparatus information, and
determines the motion of transferring the object is able to be executed on the object at the motion place according to the size information and the range information.

### (Supplementary Note 10)

The motion determination system according to supplementary note 8 or 9, in which the range information acquisition means acquires the range information at the motion place specified according to the object information.

### (Supplementary Note 11)

The motion determination system according to any one of supplementary notes 8 to 10, in which
the mobile apparatus includes loading means for loading the object, and
the apparatus information includes information indicating a size of the loading means.

### (Supplementary Note 12)

The motion determination system according to any one of supplementary notes 8 to 11, further including in a case where the determination means that the motion of transferring the object is not able to be executed on the object, means for executing at least one of processing of stopping the motion of transferring the object by the mobile apparatus and processing of notifying a management apparatus that manages movement of the mobile apparatus.

### (Supplementary Note 13)

The motion determination system according to any one of supplementary notes 8 to 12, in which
the mobile apparatus includes loading means for loading the object, and lifting or lowering means for lifting or lowering the loading means,
the apparatus information includes information indicating a height of the loading means with respect to a reference position in the mobile apparatus,
the object information includes at least information indicating a height of the object, and
the range information includes at least information indicating a range in a height direction.

### (Supplementary Note 14)

The motion determination system according to supplementary note 13, in which
the mobile apparatus includes horizontal moving means for moving the loading means in a horizontal direction,
the apparatus information includes information indicating a position of the loading means in a horizontal direction with respect to a reference position in the mobile apparatus,
the object information includes at least information indicating a length of the object in a horizontal direction, and
the range information includes at least information indicating a range in a horizontal direction.

### (Supplementary Note 15)

A motion determination apparatus including
object information acquisition means for acquiring object information including information regarding a size of an object,
apparatus information acquisition means for acquiring apparatus information that is information regarding a mobile apparatus that moves the object,
range information acquisition means for acquiring range information indicating a range in which an object can be moved at a motion place where a motion of transferring the object by a mobile apparatus is executed, and
determination means for determining the motion of transferring the object is able to be executed on the object at the motion place according to the object information, the apparatus information, and the range information.

### (Supplementary Note 16)

The motion determination apparatus according to supplementary note 15, in which
the determination means
specifies size information indicating a size necessary for enabling the mobile apparatus to execute the motion of transferring the object on the object based on the object information and the apparatus information, and
determines the motion of transferring the object is able to be executed on the object at the motion place according to the size information and the range information.

### (Supplementary Note 17)

The motion determination apparatus according to supplementary note 15 or 16, in which the range information acquisition means acquires the range information at the motion place specified according to the object information.

### (Supplementary Note 18)

The motion determination apparatus according to any one of supplementary notes 15 to 17, in which
the mobile apparatus includes loading means for loading the object, and
the apparatus information includes information indicating a size of the loading means.

### (Supplementary Note 19)

The motion determination apparatus according to any one of supplementary notes 15 to 18, further including in a case where the determination means that the motion of transferring the object is not able to be executed on the object, means for executing at least one of processing of stopping the motion of transferring the object by the mobile apparatus and processing of notifying a management apparatus that manages movement of the mobile apparatus.

### (Supplementary Note 20)

The motion determination apparatus according to any one of supplementary notes 15 to 19, in which
the mobile apparatus includes loading means for loading the object, and lifting or lowering means for lifting or lowering the loading means,
the apparatus information includes information indicating a height of the loading means with respect to a reference position in the mobile apparatus,
the object information includes at least information indicating a height of the object, and
the range information includes at least information indicating a range in a height direction.

### (Supplementary Note 21)

The motion determination apparatus according to supplementary note 20, in which
the mobile apparatus includes horizontal moving means for moving the loading means in a horizontal direction,
the apparatus information includes information indicating a position of the loading means in a horizontal direction with respect to a reference position in the mobile apparatus,
the object information includes at least information indicating a length of the object in a horizontal direction, and
the range information includes at least information indicating a range in a horizontal direction.

### (Supplementary Note 22)

A program for causing a computer to execute motion determination processing including
acquiring object information including information regarding a size of an object,
acquiring apparatus information that is information regarding a mobile apparatus that moves the object,
acquiring range information indicating a range in which an object can be moved at a motion place where a motion of transferring the object by a mobile apparatus is executed, and
determining the motion of transferring the object is able to be executed on the object at the motion place according to the object information, the apparatus information, and the range information.

### (Supplementary Note 23)

The program according to supplementary note 22, in which
the determining includes
specifying size information indicating a size necessary for enabling the mobile apparatus to execute the motion of transferring the object on the object based on the object information and the apparatus information, and
determining the motion of transferring the object is able to be executed on the object at the motion place according to the size information and the range information.

### (Supplementary Note 24)

The program according to supplementary note 22 or 23, in which the acquiring the range information includes acquiring the range information at the motion place specified according to the object information.

### (Supplementary Note 25)

The program according to any one of supplementary notes 22 to 24, in which
the mobile apparatus includes loading means for loading the object, and
the apparatus information includes information indicating a size of the loading means.

### (Supplementary Note 26)

The program according to any one of supplementary notes 22 to 25, in which the motion determination processing further includes, in a case where it is determined that the motion of transferring the object is not able to be executed on the object, executing at least one of processing of stopping the motion of transferring the object by the mobile apparatus and processing of notifying a management apparatus that manages movement of the mobile apparatus.

### (Supplementary Note 27)

The program according to any one of supplementary notes 22 to 26, in which
the mobile apparatus includes loading means for loading the object, and lifting or lowering means for lifting or lowering the loading means,
the apparatus information includes information indicating a height of the loading means with respect to a reference position in the mobile apparatus,
the object information includes at least information indicating a height of the object, and
the range information includes at least information indicating a range in a height direction.

### (Supplementary Note 28)

The program according to supplementary note 27, in which
the mobile apparatus includes horizontal moving means for moving the loading means in a horizontal direction,
the apparatus information includes information indicating a position of the loading means in a horizontal direction with respect to a reference position in the mobile apparatus,
the object information includes at least information indicating a length of the object in a horizontal direction, and
the range information includes at least information indicating a range in a horizontal direction.

### (Supplementary Note 29)

The motion determination method including
acquiring object information including information regarding a size of an object that is a person or a robot,
acquiring apparatus information that is information of a mobile apparatus that loads the object onto loading means and moves the object,
acquiring range information indicating a range in which an object can be moved at a motion place where the object is moved by the mobile apparatus, and
determining the motion of transferring the object is able to be executed on the object at the motion place according to the object information, the apparatus information, and the range information.

### (Supplementary Note 30)

The motion determination method according to supplementary note 29, in which
the motion place is a place where a wall exists on an upper surface side,
the range information includes at least information indicating a height of the wall,
the object information includes at least information indicating a height of the object, and
the apparatus information includes information indicating a height of the loading means with respect to a reference position in the mobile apparatus.

### (Supplementary Note 31)

A motion determination system including
object information acquisition means for acquiring object information including information regarding a size of an object that is a person or a robot,
apparatus information acquisition means for acquiring apparatus information that is information regarding a mobile apparatus that loads and moves the object on loading means,
range information acquisition means for acquiring range information indicating a range in which an object can be moved at a motion place where the object is moved by the mobile apparatus, and
determination means for determining the motion of transferring the object is able to be executed on the object at the motion place according to the object information, the apparatus information, and the range information.

### (Supplementary Note 32)

The motion determination system according to supplementary note 31, in which
the motion place is a place where a wall exists on an upper surface side,
the range information includes at least information indicating a height of the wall,
the object information includes at least information indicating a height of the object, and
the apparatus information includes information indicating a height of the loading means with respect to a reference position in the mobile apparatus.

### (Supplementary Note 33)

A motion determination apparatus including
object information acquisition means for acquiring object information including information regarding a size of an object that is a person or a robot,
apparatus information acquisition means for acquiring apparatus information that is information regarding a mobile apparatus that loads and moves the object on loading means,
range information acquisition means for acquiring range information indicating a range in which an object can be moved at a motion place where the object is moved by the mobile apparatus, and
determination means for determining the motion of transferring the object is able to be executed on the object at the motion place according to the object information, the apparatus information, and the range information.

### (Supplementary Note 34)

The motion determination apparatus according to supplementary note 33, in which the motion place is a place where a wall exists on an upper surface side,
the range information includes at least information indicating a height of the wall,
the object information includes at least information indicating a height of the object, and
the apparatus information includes information indicating a height of the loading means with respect to a reference position in the mobile apparatus.

### (Supplementary Note 35)

A program for causing a computer to execute motion determination processing including
acquiring object information including information regarding a size of an object that is a person or a robot,
acquiring apparatus information that is information of a mobile apparatus that loads the object onto loading means and moves the object,
acquiring range information indicating a range in which an object can be moved at a motion place where the object is moved by the mobile apparatus, and
determining the motion of transferring the object is able to be executed on the object at the motion place according to the object information, the apparatus information, and the range information.

### (Supplementary Note 36)

The program according to supplementary note 35, in which
the motion place is a place where a wall exists on an upper surface side,
the range information includes at least information indicating a height of the wall,
the object information includes at least information indicating a height of the object, and
the apparatus information includes information indicating a height of the loading means with respect to a reference position in the mobile apparatus.

### REFERENCE SIGNS LIST

Ca CARGO, OBJECT (PERSON OR ROBOT)
Cp CARGO LOADING PALLET
Csb UPPER SURFACE OF LOWER FRAME
Csu LOWER SURFACE OF UPPER FRAME
F, Faa FORKLIFT
Fa LIFT PORTION
Fb FORK
Fs LOADING SURFACE
Ma LADDER
Mb WORKING DECK
Mt TUNNEL INSPECTION VEHICLE
T TRUCK
Td BOTTOM SURFACE OF LOADING PLATFORM
Tu CEILING OF LOADING PLATFORM
TN TUNNEL
Tar INSPECTION TARGET POINT
1, 100, 100a, 100b MOTION DETERMINATION SYSTEM
1a, 11a, 21a OBJECT INFORMATION ACQUISITION UNIT
1b, 11b, 21b APPARATUS INFORMATION ACQUISITION UNIT
1c, 11c, 21c RANGE INFORMATION ACQUISITION UNIT
1d, 11d, 21d DETERMINATION UNIT
2 MOTION DETERMINATION APPARATUS
20, 20a, 20b REMOTE CONTROL APPARATUS
11, 21 CONTROL UNIT
12, 22, 32 COMMUNICATION UNIT
13 WHEEL DRIVE UNIT
14 FORK DRIVE UNIT
15 OPERATION UNIT
21e FORKLIFT CONTROL UNIT
21f INSPECTION VEHICLE CONTROL UNIT
23 DISPLAY UNIT
24 OPERATION INPUT UNIT
30 CAMERA
31 SENSOR
500 APPARATUS
510 CPU
520 STORAGE UNIT
530 ROM
540 RAM
550 COMMUNICATION INTERFACE
560 USER INTERFACE

What is claimed is:

1. A motion determination method comprising:
acquiring object information including information regarding a size of an object;
acquiring apparatus information that is information regarding a mobile apparatus that moves the object;
acquiring range information indicating a range in which an object can be moved at a motion place where a motion of transferring the object by a mobile apparatus is executed; and
determining whether the motion of transferring the object is able to be executed on the object at the motion place according to the object information, the apparatus information, and the range information.

2. The motion determination method according to claim 1, wherein
the determining includes
specifying size information indicating a size necessary for enabling the mobile apparatus to execute the motion of transferring the object on the object based on the object information and the apparatus information, and
determining the motion of transferring the object is able to be executed on the object at the motion place according to the size information and the range information.

3. The motion determination method according to claim 1, wherein the acquiring the range information includes acquiring the range information at the motion place specified according to the object information.

4. The motion determination method according to claim 1, wherein
the mobile apparatus includes a loading portion for loading the object, and
the apparatus information includes information indicating a size of the loading portion.

5. The motion determination method according to claim 1, wherein
the mobile apparatus includes a loading portion for loading the object, and a lifting or lowering portion for lifting or lowering the loading portion,
the apparatus information includes information indicating a height of the loading portion with respect to a reference position in the mobile apparatus,
the object information includes at least information indicating a height of the object, and
the range information includes at least information indicating a range in a height direction.

6. The motion determination method according to claim 5, wherein
the mobile apparatus includes a horizontal moving portion for moving the loading portion in a horizontal direction,
the apparatus information includes information indicating a position of the loading portion in a horizontal direction with respect to a reference position in the mobile apparatus,
the object information includes at least information indicating a length of the object in a horizontal direction, and
the range information includes at least information indicating a range in a horizontal direction.

7. A motion determination system comprising:
at least one memory storing instructions; and
at least one processor configured to execute the instructions to do motion determination process, wherein the motion determination process includes:
acquiring object information including information regarding a size of an object;
acquiring apparatus information that is information regarding a mobile apparatus that moves the object;
acquiring range information indicating a range in which an object can be moved at a motion place where a motion of transferring the object by a mobile apparatus is executed; and
determining the motion of transferring the object is able to be executed on the object at the motion place according to the object information, the apparatus information, and the range information.

8. The motion determination system according to claim 7, wherein
the determining includes
specifying size information indicating a size necessary for enabling the mobile apparatus to execute the motion of transferring the object on the object based on the object information and the apparatus information, and
determining the motion of transferring the object is able to be executed on the object at the motion place according to the size information and the range information.

9. The motion determination system according to claim 7, wherein the acquiring the range information includes acquiring the range information at the motion place specified according to the object information.

10. The motion determination system according to claim 7, wherein
the mobile apparatus includes a loading portion for loading the object, and
the apparatus information includes information indicating a size of the loading portion.

11. The motion determination system according to claim 7, wherein
the mobile apparatus includes a loading portion for loading the object, and a lifting or lowering portion for lifting or lowering the loading portion,
the apparatus information includes information indicating a height of the loading portion with respect to a reference position in the mobile apparatus,
the object information includes at least information indicating a height of the object, and
the range information includes at least information indicating a range in a height direction.

12. The motion determination system according to claim 11, wherein
the mobile apparatus includes a horizontal moving portion for moving the loading portion in a horizontal direction,
the apparatus information includes information indicating a position of the loading portion in a horizontal direction with respect to a reference position in the mobile apparatus,
the object information includes at least information indicating a length of the object in a horizontal direction, and
the range information includes at least information indicating a range in a horizontal direction.

13. A motion determination apparatus comprising:
at least one memory storing instructions; and
at least one processor configured to execute the instructions to do motion determination process, wherein the motion determination process includes:
acquiring object information including information regarding a size of an object;
acquiring apparatus information that is information regarding a mobile apparatus that moves the object;
acquiring range information indicating a range in which an object can be moved at a motion place where a motion of transferring the object by a mobile apparatus is executed; and
determining the motion of transferring the object is able to be executed on the object at the motion place according to the object information, the apparatus information, and the range information.

14. The motion determination apparatus according to claim 13, wherein
the determining includes
specifying size information indicating a size necessary for enabling the mobile apparatus to execute the motion of transferring the object on the object based on the object information and the apparatus information, and
determining the motion of transferring the object is able to be executed on the object at the motion place according to the size information and the range information.

15. The motion determination apparatus according to claim 13, wherein the acquiring the range information includes the range information at the motion place specified according to the object information.

16. The motion determination apparatus according to claim 13, wherein
the mobile apparatus includes a loading portion for loading the object, and
the apparatus information includes information indicating a size of the loading portion.

17. The motion determination apparatus according to claim 13, wherein
the mobile apparatus includes a loading portion for loading the object, and a lifting or lowering portion for lifting or lowering the loading portion,
the apparatus information includes information indicating a height of the loading portion with respect to a reference position in the mobile apparatus,
the object information includes at least information indicating a height of the object, and
the range information includes at least information indicating a range in a height direction.

18. The motion determination apparatus according to claim 17, wherein
the mobile apparatus includes a horizontal moving portion for moving the loading portion in a horizontal direction,
the apparatus information includes information indicating a position of the loading portion in a horizontal direction with respect to a reference position in the mobile apparatus,
the object information includes at least information indicating a length of the object in a horizontal direction, and
the range information includes at least information indicating a range in a horizontal direction.
